(19) United States
(12) Patent Application Publication
(10) Pub. No.: US 2026/0261374 A1
(43) Pub. Date: Sep. 3, 2026

(54) METHODS, COMMUNICATIONS DEVICES AND INFRASTRUCTURE EQUIPMENT

(71) Applicant: Sony Group Corporation, Tokyo (JP)

(72) Inventors: Shin Horng WONG, Basingstoke (GB); Yassin Aden AWAD, Basingstoke (GB); Naoki KUSASHIMA, Tokyo (JP)

(73) Assignee: Sony Group Corporation, Tokyo (JP)

(21) Appl. No.: 18/994,611

(22) PCT Filed: Jul. 26, 2023
(86) PCT No.: PCT/EP2023/070706

§ 371 Date: Jan. 15, 2025

(30) Foreign Application Priority Data
Jul. 27, 2022 (EP) 22187206.2

(51) Int. Cl. H04L 5/00

(52) U.S. Cl. CPC H04L 5/0044

(57) ABSTRACT

A method for operating a communications device involves receiving a control signal from a wireless network to indicate resource allocation for uplink or downlink transmissions. The allocation covers a set of contiguous resource units, including uplink and downlink frequency sets with multiple resource units. The control signal, configured with bits, specifies resource allocation for uplink transmissions based on the total number of uplink resource units or for downlink transmissions based on the total number of downlink resource units. The device determines the allocation from the control signal and transmits uplink data or receives downlink data accordingly.

### BACKGROUND

### Field of Disclosure

The present disclosure relates to communications devices, infrastructure equipment and methods of operating communications devices and infrastructure equipment in a wireless communications network.

The present application claims the Paris Convention priority of European patent application number EP22187206.2, the contents of which are hereby incorporated by reference in their entirety.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Previous generation mobile telecommunication systems, such as those based on the 3GPP defined UMTS and Long Term Evolution (LTE) architecture, are able to support a wider range of services than simple voice and messaging services offered by previous generations of mobile telecommunication systems. For example, with the improved radio interface and enhanced data rates provided by LTE systems, a user is able to enjoy high data rate applications such as mobile video streaming and mobile video conferencing that would previously only have been available via a fixed line data connection. The demand to deploy such networks is therefore strong and the coverage area of these networks, i.e. geographic locations where access to the networks is possible, is expected to continue to increase rapidly.

Current and future wireless communications networks are expected to routinely and efficiently support communications with an ever-increasing range of devices associated with a wider range of data traffic profiles and types than existing systems are optimised to support. For example, it is expected future wireless communications networks will be expected to efficiently support communications with devices including reduced complexity devices, machine type communication (MTC) devices, high resolution video displays, virtual reality headsets, extended Reality (XR) and so on. Some of these different types of devices may be deployed in very large numbers, for example low complexity devices for supporting the “The Internet of Things”, and may typically be associated with the transmissions of relatively small amounts of data with relatively high latency tolerance. Other types of device, for example supporting high-definition video streaming, may be associated with transmissions of relatively large amounts of data with relatively low latency tolerance. Other types of device, for example used for autonomous vehicle communications and for other critical applications, may be characterised by data that should be transmitted through the network with low latency and high reliability. A single device type might also be associated with different traffic profiles/characteristics depending on the application(s) it is running. For example, different consideration may apply for efficiently supporting data exchange with a smartphone when it is running a video streaming application (high downlink data) as compared to when it is running an Internet browsing application (sporadic uplink and downlink data) or being used for voice communications by an emergency responder in an emergency scenario (data subject to stringent reliability and latency requirements).

In view of this there is expected to be a desire for current wireless communications networks, for example those which may be referred to as 5G or new radio (NR) systems/new radio access technology (RAT) systems, or indeed future 6G wireless communications, as well as future iterations/releases of existing systems, to efficiently support connectivity for a wide range of devices associated with different applications and different characteristic data traffic profiles and requirements.

One example of a new service is referred to as Ultra Reliable Low Latency Communications (URLLC) services which, as its name suggests, requires that a data unit or packet be communicated with a high reliability and with a low communications delay. Another example of a new service is enhanced Mobile Broadband (eMBB) services, which are characterised by a high capacity with a requirement to support up to 20 Gb/s. URLLC and eMBB type services therefore represent challenging examples for both LTE type communications systems and 5G/NR communications systems.

5G NR has continuously evolved and the current work plan includes 5G-NR-advanced in which some further enhancements are expected, especially to support new use-cases/scenarios with higher requirements. The desire to support these new use-cases and scenarios gives rise to new challenges for efficiently handling communications in wireless communications systems that need to be addressed.

### SUMMARY OF THE DISCLOSURE

The present disclosure can help address or mitigate at least some of the issues discussed above.

Embodiments of the present technique can provide a method of operating a communications device. The method comprises receiving, from infrastructure equipment of a wireless communications network, a control signal configured with one or more bits to indicate a resource allocation for transmitting an uplink transmission to the infrastructure equipment or receiving a downlink transmission from the infrastructure equipment within a set of contiguous resource units of a wireless radio interface. The set of contiguous resource units comprises one or more uplink frequency sets each comprising a plurality of uplink resource units and one or more downlink frequency sets each comprising a plurality of downlink resource units. The resource allocation comprises at least one of the uplink resource units in the one or more uplink frequency sets for the uplink transmission or at least one of the downlink resource units in the one or more downlink frequency sets for the downlink transmission. The control signal is configured with the one or more bits to either indicate the resource allocation for the uplink transmission based on a total number of the uplink resource units in the one or more uplink frequency sets, or indicate the resource allocation for the downlink transmission based on a total number of the downlink resource units in the one or more downlink frequency sets. The method comprises determining the resource allocation for the uplink or the downlink transmission based on the one or more bits. The method comprises transmitting the uplink transmission to the infrastructure equipment or receiving the downlink transmission from the infrastructure equipment in accordance with the resource allocation.

Embodiments of the present technique can provide another method of operating communications device. The method comprises receiving, from infrastructure equipment of a wireless communications network, a control signal indicating a resource allocation for transmitting an uplink transmission to the infrastructure equipment or receiving a downlink transmission from the infrastructure equipment within a set of contiguous resource units of a wireless radio interface. The resource allocation comprises a plurality of the resource units in the contiguous set of resource units for the uplink transmission or the downlink transmission. The method comprises applying a frequency domain mask to a sub-set of the plurality of resource units in the resource allocation. The frequency domain mask disables the sub-set of the plurality of resource units in the resource allocation for transmitting the uplink transmission or receiving the downlink transmission. The method comprises transmitting the uplink transmission to the infrastructure equipment, or receiving the downlink transmission from the infrastructure equipment, in the other resource units in the resource allocation to which the frequency domain mask was not applied.

Embodiments of the present technique, which, in addition to methods of operating communications devices, relate to methods of operating infrastructure equipment, communications devices and infrastructure equipment, circuitry for communications devices and infrastructure equipment, computer programs, and computer-readable storage mediums, can allow for the more efficient use of radio resources by a communications device operating in a wireless communications network.

Respective aspects and features of the present disclosure are defined in the appended claims.

It is to be understood that both the foregoing general description and the following detailed description are exemplary, but are not restrictive, of the present technology. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein like reference numerals designate identical or corresponding parts throughout the several views, and wherein:

FIG. 1 schematically represents some aspects of an LTE-type wireless telecommunication system which may be configured to operate in accordance with certain embodiments of the present disclosure;

FIG. 2 schematically represents some aspects of a new radio access technology (RAT) wireless telecommunications system which may be configured to operate in accordance with certain embodiments of the present disclosure;

FIG. 3 is a schematic block diagram of an example infrastructure equipment and communications device which may be configured to operate in accordance with certain embodiments of the present disclosure;

FIG. 4 schematically illustrates an example of inter-cell cross link interference;

FIG. 5 illustrates an example approach for accounting for inter-cell cross link interference;

FIG. 6 schematically illustrates an example of intra-cell cross link interference;

FIG. 7 illustrates an example division of system bandwidth into dedicated uplink and downlink sub-bands;

FIG. 8 illustrates an example of transmission power leakage;

FIG. 9 illustrates an example of receiver power selectivity;

FIG. 10 illustrates an example of inter sub-band interference;

FIG. 11 illustrates an example of intra sub-band interference;

FIG. 12 shows an example of interlaced Physical Uplink Shared Channel (PUSCH) allocation for 30 kHz subcarrier spacing (SCS);

FIG. 13 shows an example of a first Sub-band Full Duplex (SBFD) configuration;

FIG. 14 shows an example of a second SBFD configuration;

FIG. 15 is a flow diagram illustrating a method performed by a communications device in accordance with example embodiments;

FIG. 16 is a flow diagram illustrating a method performed by infrastructure equipment of a wireless communications network in accordance with example embodiments;

FIG. 17 schematically illustrates an arrangement of resource blocks in an SBFD configuration in accordance with example embodiments;

FIG. 18 schematically illustrates an index for a BWP, DL subband and UL subband in accordance with example embodiments;

FIG. 19 schematically illustrates an allocation of PDSCH in an index for a DL subband in accordance with example embodiments;

FIG. 20 is a flow diagram illustrating a method performed by a communications device in accordance with example embodiments;

FIG. 21 is a flow diagram illustrating a method performed by infrastructure equipment of a wireless communications network in accordance with example embodiments;

FIG. 22 schematically illustrates a frequency domain mask in accordance with example embodiments;

FIG. 23 schematically illustrates a plurality of frequency domain masks in accordance with example embodiments.

### DETAILED DESCRIPTION OF THE EMBODIMENTS

### Long Term Evolution Advanced Radio Access Technology (4G)

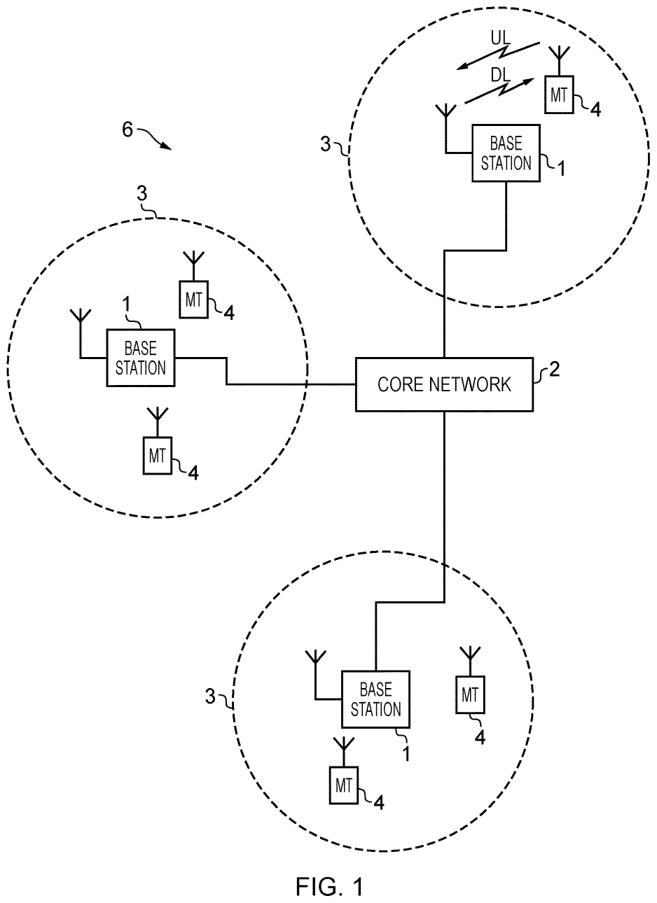

FIG. 1 provides a schematic diagram illustrating some basic functionality of a mobile telecommunications network/system 6 operating generally in accordance with LTE principles, but which may also support other radio access technologies, and which may be adapted to implement embodiments of the disclosure as described herein. Various elements of FIG. 1 and certain aspects of their respective modes of operation are well-known and defined in the relevant standards administered by the 3GPP (RTM) body, and also described in many books on the subject, for example, Holma H. and Toskala A [1]. It will be appreciated that operational aspects of the telecommunications networks discussed herein which are not specifically described (for example in relation to specific communication protocols and physical channels for communicating between different elements) may be implemented in accordance with any known techniques, for example according to the relevant standards and known proposed modifications and additions to the relevant standards.

The network 6 includes a plurality of base stations 1 connected to a core network 2. Each base station provides a coverage area 3 (i.e. a cell) within which data can be communicated to and from communications devices 4. Although each base station 1 is shown in FIG. 1 as a single entity, the skilled person will appreciate that some of the functions of the base station may be carried out by disparate, inter-connected elements, such as antennas (or antennae), remote radio heads, amplifiers, etc. Collectively, one or more base stations may form a radio access network.

Data is transmitted from base stations 1 to communications devices 4 within their respective coverage areas 3 via a radio downlink. Data is transmitted from communications devices 4 to the base stations 1 via a radio uplink. The core network 2 routes data to and from the communications devices 4 via the respective base stations 1 and provides functions such as authentication, mobility management, charging and so on. Terminal devices may also be referred to as mobile stations, user equipment (UE), user terminal, mobile radio, communications device, and so forth. Services provided by the core network 2 may include connectivity to the internet or to external telephony services. The core network 2 may further track the location of the communications devices 4 so that it can efficiently contact (i.e. page) the communications devices 4 for transmitting downlink data towards the communications devices 4.

Base stations, which are an example of network infrastructure equipment, may also be referred to as transceiver stations, nodeBs, e-nodeBs, eNB, g-nodeBs, gNB and so forth. In this regard different terminology is often associated with different generations of wireless telecommunications systems for elements providing broadly comparable functionality. However, certain embodiments of the disclosure may be equally implemented in different generations of wireless telecommunications systems, and for simplicity certain terminology may be used regardless of the underlying network architecture. That is to say, the use of a specific term in relation to certain example implementations is not intended to indicate these implementations are limited to a certain generation of network that may be most associated with that particular terminology.

### New Radio Access Technology (5G)

Systems incorporating NR technology are expected to support different services (or types of services), which may be characterised by different requirements for latency, data rate and/or reliability. For example, Enhanced Mobile Broadband (eMBB) services are characterised by high capacity with a requirement to support up to 20 Gb/s. The requirements for Ultra Reliable and Low Latency Communications (URLLC) services are for one transmission of a 32 byte packet to be transmitted from the radio protocol layer 2/3 SDU ingress point to the radio protocol layer 2/3 SDU egress point of the radio interface within 1 ms with a reliability of 1−10⁻⁵ (99.999%) or higher (99.9999%) [2].

Massive Machine Type Communications (mMTC) is another example of a service which may be supported by NR-based communications networks. In addition, systems may be expected to support further enhancements related to Industrial Internet of Things (IIoT) in order to support services with new requirements of high availability, high reliability, low latency, and in some cases, high-accuracy positioning.

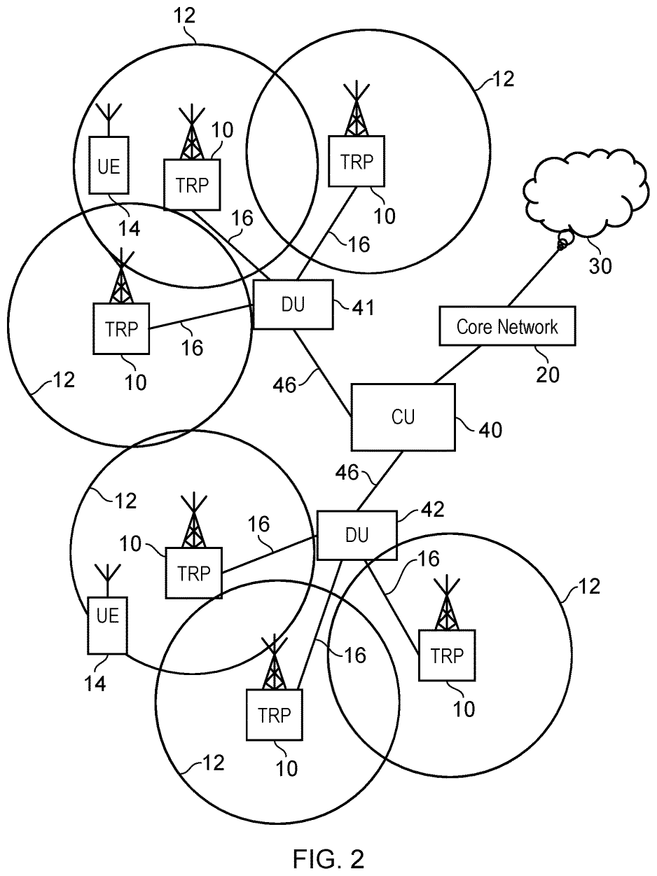

An example configuration of a wireless communications network which uses some of the terminology proposed for and used in NR and 5G is shown in FIG. 2. In FIG. 2 a plurality of transmission and reception points (TRPs) 10 are connected to distributed control units (DUs) 41, 42 by a connection interface represented as a line 16. Each of the TRPs 10 is arranged to transmit and receive signals via a wireless access interface within a radio frequency bandwidth available to the wireless communications network. Thus, within a range for performing radio communications via the wireless access interface, each of the TRPs 10, forms a cell of the wireless communications network as represented by a circle 12. As such, wireless communications devices 14 which are within a radio communications range provided by the cells 12 can transmit and receive signals to and from the TRPs 10 via the wireless access interface. Each of the distributed units 41, 42 are connected to a central unit (CU) 40 (which may be referred to as a controlling node) via an interface 46. The central unit 40 is then connected to the core network 20 which may contain all other functions required to transmit data for communicating to and from the wireless communications devices and the core network 20 may be connected to other networks 30.

The elements of the wireless access network shown in FIG. 2 may operate in a similar way to corresponding elements of an LTE network as described with regard to the example of FIG. 1. It will be appreciated that operational aspects of the telecommunications network represented in FIG. 2, and of other networks discussed herein in accordance with embodiments of the disclosure, which are not specifically described (for example in relation to specific communication protocols and physical channels for communicating between different elements) may be implemented in accordance with any known techniques, for example according to currently used approaches for implementing such operational aspects of wireless telecommunications systems, e.g. in accordance with the relevant standards.

The TRPs 10 of FIG. 2 may in part have a corresponding functionality to a base station or eNodeB of an LTE network. Similarly, the communications devices 14 may have a functionality corresponding to the UE devices 4 known for operation with an LTE network. It will be appreciated therefore that operational aspects of a new RAT network (for example in relation to specific communication protocols and physical channels for communicating between different elements) may be different to those known from LTE or other known mobile telecommunications standards. However, it will also be appreciated that each of the core network component, base stations and communications devices of a new RAT network will be functionally similar to, respectively, the core network component, base stations and communications devices of an LTE wireless communications network.

In terms of broad top-level functionality, the core network 20 connected to the new RAT telecommunications system represented in FIG. 2 may be broadly considered to correspond with the core network 2 represented in FIG. 1, and the respective central units 40 and their associated distributed units/TRPs 10 may be broadly considered to provide functionality corresponding to the base stations 1 of FIG. 1. The term network infrastructure equipment/access node may be used to encompass these elements and more conventional base station type elements of wireless telecommunications systems. Depending on the application at hand the responsibility for scheduling transmissions which are scheduled on the radio interface between the respective distributed units and the communications devices may lie with the controlling node/central unit and/or the distributed units/TRPs. A communications device 14 is represented in FIG. 2 within the coverage area of the first communication cell 12. This communications device 14 may thus exchange signalling with the first central unit 40 in the first communication cell 12 via one of the distributed units/TRPs 10 associated with the first communication cell 12.

It will further be appreciated that FIG. 2 represents merely one example of a proposed architecture for a new RAT based telecommunications system in which approaches in accordance with the principles described herein may be adopted, and the functionality disclosed herein may also be applied in respect of wireless telecommunications systems having different architectures.

Thus, certain embodiments of the disclosure as discussed herein may be implemented in wireless telecommunication systems/networks according to various different architectures, such as the example architectures shown in FIGS. 1 and 2. It will thus be appreciated the specific wireless telecommunications architecture in any given implementation is not of primary significance to the principles described herein. In this regard, certain embodiments of the disclosure may be described generally in the context of communications between network infrastructure equipment/access nodes and a communications device, wherein the specific nature of the network infrastructure equipment/access node and the communications device will depend on the network infrastructure for the implementation at hand. For example, in some scenarios the network infrastructure equipment/access node may comprise a base station, such as an LTE-type base station 1 as shown in FIG. 1 which is adapted to provide functionality in accordance with the principles described herein, and in other examples the network infrastructure equipment may comprise a control unit/controlling node 40 and/or a TRP 10 of the kind shown in FIG. 2 which is adapted to provide functionality in accordance with the principles described herein.

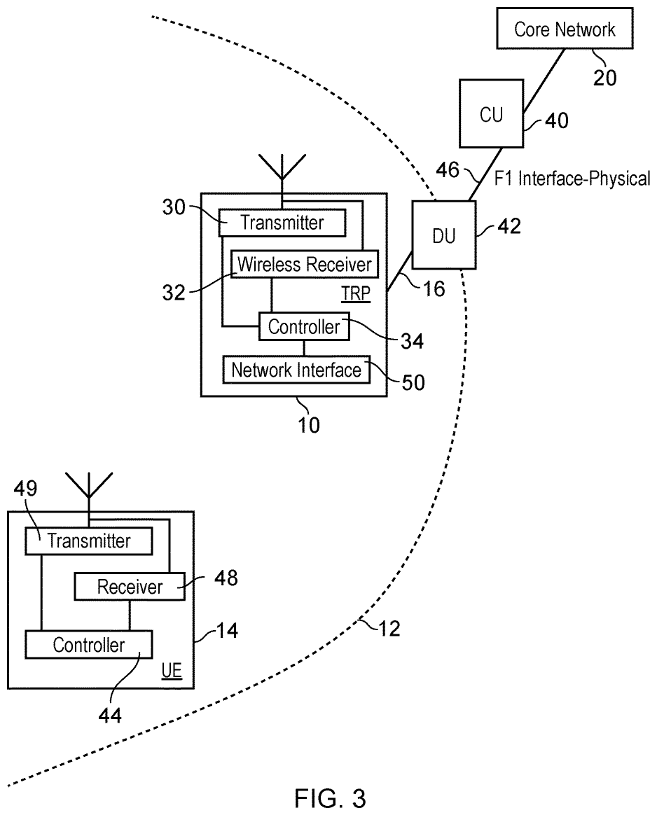

A more detailed diagram of some of the components of the network shown in FIG. 2 is provided by FIG. 3. In FIG. 3, a TRP 10 as shown in FIG. 2 comprises, as a simplified representation, a wireless transmitter 30, a wireless receiver 32 and a controller or controlling processor 34 which may operate to control the transmitter 30 and the wireless receiver 32 to transmit and receive radio signals to one or more UEs 14 within a cell 12 formed by the TRP 10. As shown in FIG. 3, an example UE 14 is shown to include a corresponding transmitter 49, a receiver 48 and a controller 44 which is configured to control the transmitter 49 and the receiver 48 to transmit signals representing uplink data to the wireless communications network via the wireless access interface formed by the TRP 10 and to receive downlink data as signals transmitted by the transmitter 30 and received by the receiver 48 in accordance with the conventional operation.

The transmitters 30, 49 and the receivers 32, 48 (as well as other transmitters, receivers and transceivers described in relation to examples and embodiments of the present disclosure) may include radio frequency filters and amplifiers as well as signal processing components and devices in order to transmit and receive radio signals in accordance for example with the 5G/NR standard. The controllers 34, 44 (as well as other controllers described in relation to examples and embodiments of the present disclosure) may be, for example, a microprocessor, a CPU, or a dedicated chipset, etc., configured to carry out instructions which are stored on a computer readable medium, such as a non-volatile memory. The processing steps described herein may be carried out by, for example, a microprocessor in conjunction with a random access memory, operating according to instructions stored on a computer readable medium. The transmitters, the receivers and the controllers are schematically shown in FIG. 3 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the infrastructure equipment/TRP/base station as well as the UE/communications device will in general comprise various other elements associated with its operating functionality.

As shown in FIG. 3, the TRP 10 also includes a network interface 50 which connects to the DU 42 via a physical interface 16. The network interface 50 therefore provides a communication link for data and signalling traffic from the TRP 10 via the DU 42 and the CU 40 to the core network 20.

The interface 46 between the DU 42 and the CU 40 is known as the F1 interface which can be a physical or a logical interface. The F1 interface 46 between CU and DU may operate in accordance with specifications 3GPP TS 38.470 and 3GPP TS 38.473, and may be formed from a fibre optic or other wired or wireless high bandwidth connection. In one example the connection 16 from the TRP 10 to the DU 42 is via fibre optic. The connection between a TRP 10 and the core network 20 can be generally referred to as a backhaul, which comprises the interface 16 from the network interface 50 of the TRP 10 to the DU 42 and the F1 interface 46 from the DU 42 to the CU 40.

### Full Duplex Time Division Duplex (FD-TDD)

NR/5G networks can operate using Time Division Duplex (TDD), where an entire frequency band or carrier is switched to either downlink or uplink transmissions for a time period and can be switched to the other of downlink or uplink transmissions at a later time period. Currently, TDD operates in Half Duplex mode (HD-TDD) where the gNB or UE can, at a given time, either transmit or receive packets, but not both at the same time. As wireless networks transition from NR to 5G-Advanced networks, a proposed new feature of such networks is to enhance duplexing operation for Time Division Multiplexing (TDD) by enabling Full Duplex operation in TDD (FD-TDD) [3], [4].

In FD-TDD, a gNB can transmit and receive data to and from the UEs at the same time on the same frequency band. In addition, a UE can operate either in HD-TDD or FD-TDD mode, depending on its capability. For example, when UEs are only capable of supporting HD-TDD, FD-TDD is achieved at the gNB by scheduling a DL transmission to a first UE and scheduling an UL transmission from a second UE within the same orthogonal frequency division multiplexing (OFDM) symbol (i.e. at the same time). Conversely, when UEs are capable of supporting FD-TDD, FD-TDD is achieved both at the gNB and the UE, where the gNB can simultaneously schedule this UE with DL and UL transmissions within the same OFDM symbol by scheduling the DL and UL transmissions at different frequencies (e.g. physical resource blocks (PRBs)) of the system bandwidth. A UE supporting FD-TDD requires more complex hardware than a UE that only supports HD-TDD. Development of current 5G networks is focused primarily on enabling FD-TDD at the gNB with UEs operating in HD-TDD mode.

Motivations for enhancing duplexing operation for TDD include an improvement in system capacity, reduced latency, and improved uplink coverage. For example, in current HD-TDD systems, OFDM symbols are allocated only for either an DL or UL direction in a semi-static manner. Hence, if one direction experiences less or no data, the spare resources cannot be used in the other direction, or are, at best, under-utilized. However, if resources can be used for DL data and UL data (as in FD-TDD) at the same time, the resource utilization in the system can be improved. Furthermore, in current HD-TDD systems, a UE can receive DL data, but cannot transmit UL data at the same time, which causes delays. If a gNB or UE is allowed to transmit and receive data at the same time (as with FD-TDD), the traffic latency will be improved. In addition, UEs are usually limited in the UL transmissions when located close to the edge of a cell. While the UE coverage at the cell-edge can be improved if more time domain resources are assigned to UL transmissions (e.g. repetitions), if the UL direction is assigned more time resources, fewer time resources can be assigned to the DL direction, which can lead to system imbalance. Enabling FD-TDD would help allow a UE to be assigned more UL time resources when required, without sacrificing DL time resources.

### Inter-Cell Cross Link Interference (CLI)

In NR systems, a slot format (i.e. the allocation of DL and UL OFDM symbols in a slot) can be semi-statically or dynamically configured, where each OFDM symbol (OS) in a slot can be configured as Downlink (DL), Uplink (UL) or Flexible (F). An OFDM symbol that is semi-statically configured to be Flexible can be indicated dynamically as DL, UL or remain as Flexible by a Dynamic Slot Format Indicator (SFI), which is transmitted in a Group Common (GC) DCI using DCI Format 2_0, where the CRC of the GC-DCI is masked with SFI-RNTI. Flexible OFDM Symbols that remain Flexible after instruction from the SFI can be changed to a DL symbol or an UL symbol by a DL Grant or a UL Grant respectively. That is, a DL Grant scheduling a PDSCH that overlaps Flexible OFDM Symbols would convert these Flexible OFDM Symbols to DL and similarly an UL Grant scheduling a PUSCH that overlaps Flexible OFDM Symbols would convert these Flexible OFDM Symbols to UL.

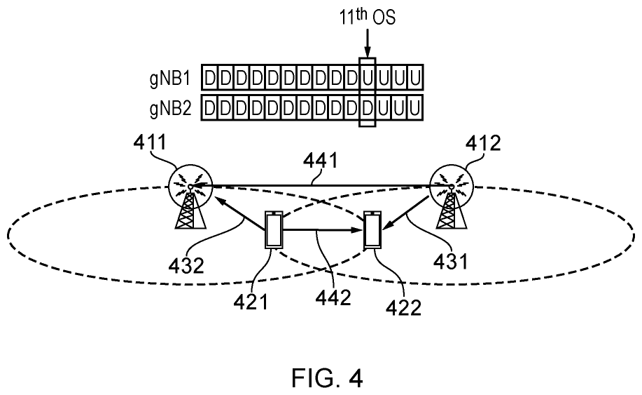

Since each gNB in a network can independently change the configuration of each OFDM symbol, either semi-statically or dynamically, it is possible that in a particular OFDM symbol, one gNB is configured for UL and a neighbour gNB is configured for DL. This causes inter-cell Cross Link Interference (CLI) among the conflicting gNBs (due to the UL/DL symbol clash for one or more symbols). Inter-cell CLI occurs when a UE's UL transmission interferes with a DL reception by another UE in another cell, or when a gNB's DL transmission interferes with an UL reception by another gNB. That is, inter-cell CLI is caused by non-aligned (conflicting) slot formats among neighbouring cells. An example is shown in FIG. 4, where gNB1 411 and gNB2 412 have synchronised slots. At a given slot, gNB1's 411 slot format={D, D, D, D, D, D, D, D, D, D, U, U, U, U} whilst gNB2's 412 slot format={D, D, D, D, D, D, D, D, D, D, D, U, U, U}, where ‘D’ indicates DL and ‘U’ indicates UL. Inter-cell CLI occurs during the 11^{th} OFDM symbol of the slot, where gNB1 411 is performing UL whilst gNB2 412 is performing DL. Specifically, inter-cell CLI 441 occurs between gNB1 411 and gNB2 412, where gNB2's 412 DL transmission 431 interferes with gNB1's 411 UL reception 432. CLI 442 also occurs between UE1 421 and UE2 422, where UE1's 421 UL transmission 432 interferes with UE2's 422 DL reception 431.

Some legacy implementations attempt to reduce inter-cell CLI in TDD networks caused by flexible and dynamic slot format configurations. Two CLI measurement reports to manage and coordinate the scheduling among neighbouring gNBs include: sounding reference signal (SRS) reference signal received power (RSRP) and CLI received signal strength indicator (RSSI). In SRS-RSRP, a linear average of the power contribution of an SRS transmitted by a UE is measured by a UE in a neighbour cell. This is measured over the configured resource elements within the considered measurement frequency bandwidth, in the time resources in the configured measurement occasions. In CLI-RSSI, a linear average of the total received power observed is measured only at certain OFDM symbols of the measurement time resource(s), in the measurement bandwidth, over the configured resource elements for measurement by a UE.

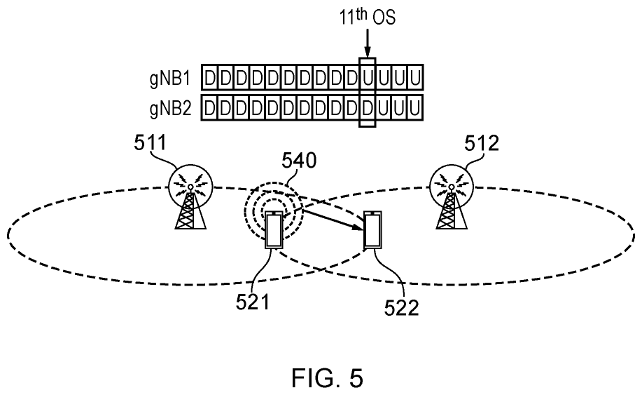

Both SRS-RSRP and CLI-RSSI are RRC measurements and are performed by a UE, for use in mitigating against UE to UE inter-cell CLI. For SRS-RSRP, an aggressor UE (i.e. a UE whose UL transmissions cause interference at another UE in a neighbouring cell) would transmit an SRS in the uplink and a victim UE (i.e. a UE that experiences interference due to an UL transmission from the UE in the neighbouring cell) in a neighbour cell would be configured with a measurement configuration including the aggressor UE's SRS parameters, in order to allow the interference from the aggressor UE to be measured. An example is shown in FIG. 5 where, at a particular slot, the 11^{th} OS (OFDM symbol) of gNB1 511 and gNB2 512 causes inter-cell CLI. Here, gNB1 511 has configured UE1 521, the aggressor UE, to transmit an SRS 540 and gNB2 512 has configured UE2 522, the victim UE, to measure that SRS 540. UE2 522 is provided with UE1's 521 SRS configured parameters, e.g. RS sequence used, frequency resource, frequency transmission comb structure and time resources, so that UE2 522 can measure the SRS 540. In general, a UE can be configured to monitor 32 different SRSs, at a maximum rate of 8 SRSs per slot.

For CLI-RSSI measurements, the UE measures the total received power, i.e. signal and interference, following a configured periodicity, start and end OFDM symbols of a slot, and a set of frequency Resource Blocks (RBs). Since SRS-RSRP measures a transmission by a specific UE, the network can target a specific aggressor UE to reduce its transmission power and in some cases not schedule the aggressor UE at the same time as a victim UE that reports a high SRS-RSRP measurement. In contrast, CLI-RSSI cannot be used to identify a specific aggressor UE's transmission, but CLI-RSSI does provide an overall estimate of the inter-cell CLI experienced by the victim UE.

### Intra-Cell Cross Link Interference (CLI) and Sub-Band Full Duplex (SBFD)

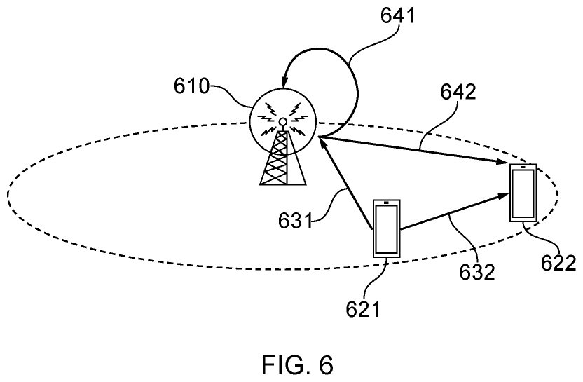

In addition to inter-cell CLI and remote interference, FD-TDD also suffers from intra-cell CLI at the gNB and at the UE. An example is shown in FIG. 6, where a gNB 610 is capable of FD-TDD and is simultaneously receiving UL transmission 631 from UE1 621 and transmitting a DL transmission 642 to UE2 622. At the gNB 610, intra-cell CLI is caused by the DL transmission 642 at the gNB's transmitter self-interfering 641 with its own receiver that is trying to decode UL signals 631. At UE2 622, intra-cell CLI 632 is caused by an aggressor UE, e.g. UE1 621, transmitting in the UL 631, whilst a victim UE, e.g. UE2 622, is receiving a DL signal 642.

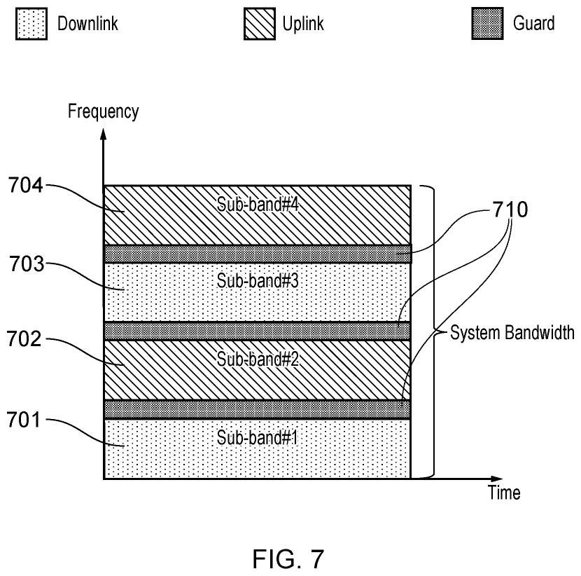

The intra-cell CLI at the gNB due to self-interference can be significant, as the DL transmission can in some cases be over 100 dB more powerful than the UL reception. Accordingly, complex RF hardware and interference cancellation are required to isolate this self-interference. In order to reduce self-interference at the gNB, one possibility being considered in [3], [4] is Sub-band Full Duplex (SBFD). In SBFD, the frequency resource of a TDD system bandwidth or Bandwidth Part (BWP) (i.e. at the UE/gNB) is divided into two or more non-overlapping sub-bands, where each sub-band can be DL or UL [5]. An example is shown in FIG. 7, where simultaneous DL and UL transmissions occur in different non-overlapping sub-bands 701 to 704, i.e. in different sets of frequency Resource Blocks (RB): Sub-band #1 701, Sub-band #2 702, Sub-band #3 703 and Sub-band #4 704 such that Sub-band #1 701 and Sub-band #3 703 are used for DL transmissions whilst Sub-band #2 702 and Sub-band #4 704 are used for UL transmissions.

While FIG. 7 shows the system bandwidth as being divided into four sub-bands, substantially any number of sub-bands could be used. For example, the system bandwidth may be divided into three sub-bands, which may include two downlink sub-bands 701, 703 and one uplink sub-band 702, though other sub-band arrangements are envisioned. To reduce leakage from one sub-band 701 to 704 to another, a guard sub-band 710 may be configured between UL and DL sub-bands 701 to 704. Guard sub-bands 710 are configured between UL Sub-band #4 704 and DL Sub-band #3 703, between DL Sub-band #3 703 and UL Sub-band #2 702 and between UL Sub-band #2 702 and DL Sub-band #1 701. The arrangement of sub-bands 701 to 704 shown in FIG. 7 is just one possible arrangement of the sub-bands and other arrangements are possible, and guard bands may be used in substantially any sub-band arrangement.

### Inter Sub-Band Interference

In addition to inter-cell Cross Link Interference, SBFD also suffers from inter (and intra) sub-band interferences, which are caused by transmission leakage and receiver's selectivity. Although a transmission is typically scheduled within a specific frequency channel (or sub-band), i.e. a specific set of RBs, transmission power can leak out to other channels. This occurs because channel filters are not perfect, and as such the roll-off of the filter will cause power to leak into channels adjacent to the intended specific frequency channel. While the following discussion uses the term “channel”, the term “sub-band”, such as the sub-bands shown in FIG. 7, may be used instead.

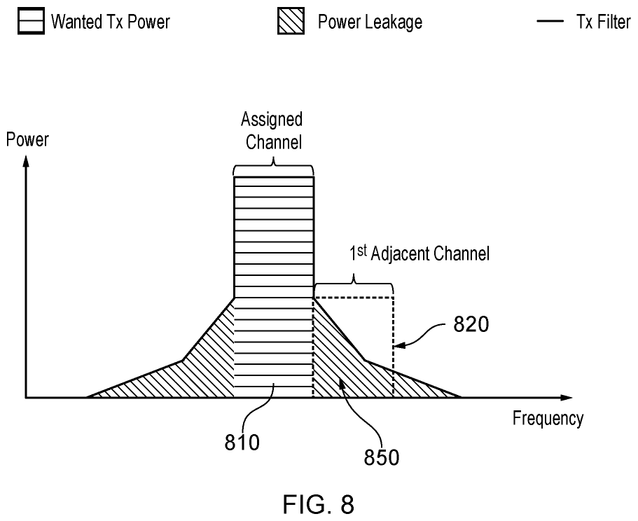

An example of transmission generating adjacent channel leakage is shown in FIG. 8. Here, the wanted transmission (Tx) power is the transmission power in the selected frequency band (i.e. the assigned channel 810). Due to roll-off of the transmission filter and nonlinearities in components of the transmitter, some transmission power is leaked into adjacent channels (including an adjacent channel 820), as shown in FIG. 8. The ratio of the power within the assigned frequency channel 810 to the power in the adjacent channel 820 is the Adjacent Channel Leakage Ratio (ACLR). The leakage power 850 will cause interference at a receiver that is receiving the signal in the adjacent channels 820.

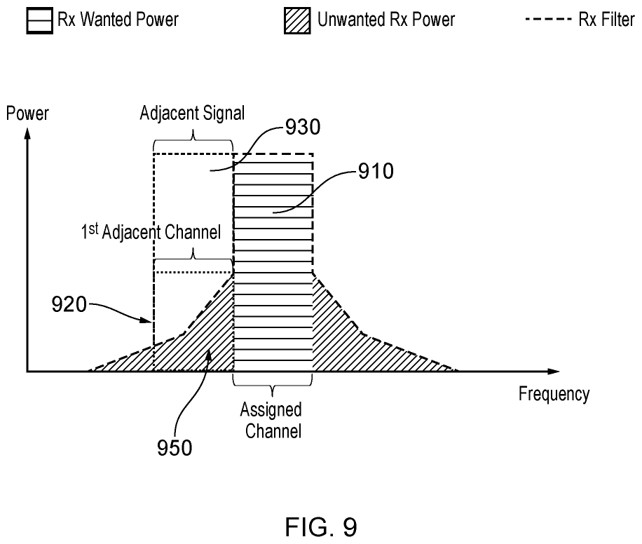

Similarly, a receiver's filter is also not perfect and will receive unwanted power from adjacent channels due to its own filter roll-off. An example of filter roll-off at a receiver is shown in FIG. 9. Here, a receiver is configured to receive transmissions in an assigned channel 910. However, the imperfect nature of the receiver filter means that some transmission power 950 can be received in adjacent channels 920. Therefore, if a signal 930 is transmitted on an adjacent channel 920, the receiver will inadvertently receive the adjacent signal 930 in the adjacent channel 920, to an extent. The ratio of the received power in the assigned frequency channel 910 to the received power 950 in the adjacent channel 920 is the Adjacent Channel Selectivity (ACS).

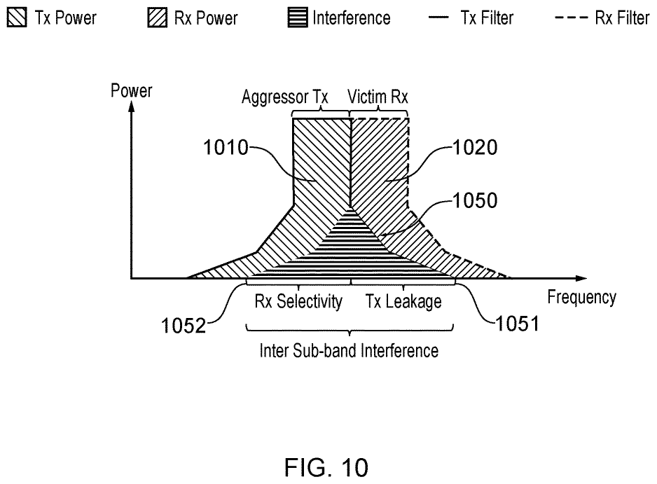

The combination of the ACL from the transmitter and the ACS of a receiver will lead to adjacent channel interference (ACI), otherwise known as inter-sub-band interference, at the receiver. An example is shown in FIG. 10, where an aggressor transmits a signal 1010 in an adjacent channel at a lower frequency than the victim's receiving 1020 channel. The interference 1050 caused by the aggressor's transmission includes the ACL 1051 of the aggressor's transmitting filter and the ACS 1052 of the victim's receiving filter. In other words, the receiver will experience interference 1050 in the ACI frequency range shown in FIG. 10.

As such, due to adjacent channel interference (ACI), cross link interference (CLI) will still occur despite the use of different sub-bands 701 to 704 for DL and UL transmissions in a FD-TDD cell as shown in the example of FIG. 7. The proposed SRS-RSRP and CLI-RSSI measurements specified for inter-cell CLI assume that an aggressor and a victim transmit and receive in the same frequency channel. That is, the measurements for SRS-RSRP and CLI-RSSI at a victim UE are performed in the same frequency channel as the aggressor's frequency channel. These approaches therefore do not take into account ACI and the use of sub-bands 701 to 704 to provide information for the scheduler to mitigate against intra-cell CLI.

### Intra Sub-Band Interference

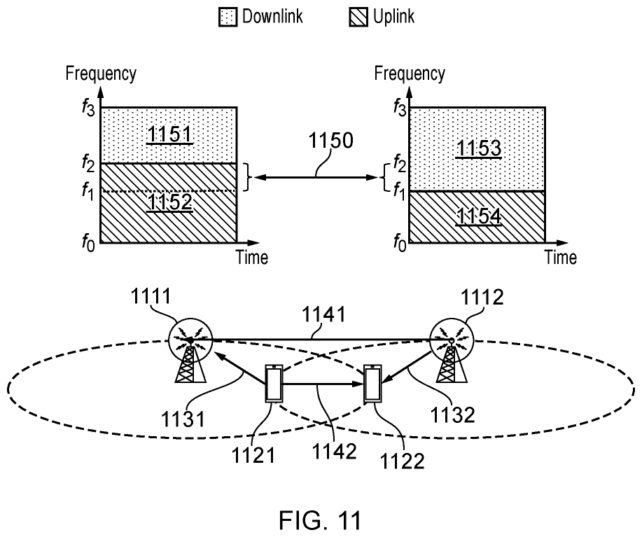

Intra sub-band interference can occur when the sub-band configurations among gNBs are not aligned in the frequency domain. Here, CLI may occur in the overlapping frequencies of inter-cell sub-bands. An example is shown in FIG. 11, where gNB1's 1111 system bandwidth is divided into UL sub-band UL-SB #1 1152 occupying f₀ to f₂ and DL sub-band DL-SB #1 1151 occupying f₂ to f₃, whilst gNB2's 1112 system bandwidth is divided into UL sub-band UL-SB #2 1154 occupying f₀ to f₁ and DL sub-band DL-SB #2 1153 occupying f₁ to f₃. The non-aligned sub-band configurations 1150 cause UL-SB #1 1152 to overlap with DL-SB #2 1153, thereby causing intra sub-band CLI within the overlapping frequencies f₁ to f₂. In this example, intra sub-band CLI 1141 occurs at gNB1 1111 due to gNB2's 1112 DL transmission 1132 within f₁ to f₂ in DL-SB #2 1153 interfering with gNB1's 1111 UL reception 1131 from UE1 1121 within f₁ to f₂ in UL-SB #1 1152. In addition, intra sub-band CLI 1142 occurs at UE2 1122 due to UE1's 1121 UL transmission 1131 within f₁ to f₂ in UL-SB #1 1152 interfering with UE2's 1122 DL reception 1132 within f₁ to f₂ in DL-SB #2 1153.

### Frequency Domain Resource Assignment (FDRA)

The PDSCH frequency resource is allocated in a DL Grant or an activation DCI for SPS. Similarly, the PUSCH frequency resource is allocated in an UL Grant or an activation DCI for CG-PUSCH. The frequency resource allocation is indicated in the Frequency Domain Resource Assignment (FDRA) field of the DCI for PDSCH and PUSCH. There are three types of FDRA, where Type 0 and Type 1 are used for PDSCH and PUSCH, and Type 2 is used for only PUSCH in Rel-17 (i.e. for NR unlicensed (NR-U)).

In Type 0 FDRA, the Resource Blocks (RBs) in the Bandwidth Part (BWP) are grouped into a plurality of Resource Block Groups (RBG). The total number of RBGs in a BWP is represented by N_{RBG-BWP}. The total number of RBs in an RBG (also known as the “granularity of the RBG”) is represented by N_{RB-RBG}. N_{RB-RBG} is configurable and is dependent on the total number of RBs in a BWP, N_{RB-BWP}. This is shown in Table 1 below, which is reproduced from [6], in which it is included as Table 5.1.2.2.1-1. The FDRA field consists of a bitmap including a number of bits, N_{bits}, which is equal to N_{RBG-BWP}. Each bit is configured to indicate whether or not each RBG of the BWP has been allocated with resources. This means that a gNB has the flexibility to indicate which RBG a PDSCH or PUSCH occupies; i.e. the PDSCH and PUSCH frequency resources can be discontinuous.

TABLE 1
RGB size (reproduced from [6]).

| Bandwidth Part Size | Configuration 1 | Configuration 2 |
|---|---|---|
| (N_{RB-BWP}) | (N_{RB-RBG}) | (N_{RB-RBG}) |
| 1-36 | 2 | 4 |
| 37-72 | 4 | 8 |
| 73-144 | 8 | 16 |
| 145-275 | 16 | 16 |

In Type 1 FDRA, the PDSCH or PUSCH occupies a contiguous set of RBs. The FDRA indicates the starting RB of the PDSCH or PUSCH and the length of RBs the PDSCH or PUSCH occupies. The gNB has no flexibility in allocating discontinuous RBs for the PDSCH or PUSCH as in Type 0 FDRA, but has a finer granularity of the PDSCH/PUSCH size (i.e. a granularity of one or more RBs rather than RBGs) as compared to Type 0 FDRA. The number of bits used for Type 1 FDRA is log₂┌N_{RB-BWP}(N_{RB-BWP}+1)/2┐. Thus, while Type 1 FDRA may generally be considered more efficient in the amount of resources allocated (due to the lower granularity), it is less flexible than Type 0 FDRA in that allocations cannot be discontinuous.

The UE can be configured to dynamically switch between Type 0 and Type 1, where the Most Significant Bit (MSB) (1 bit) of the FDRA is used to indicate that either Type 0 or Type 1 FDRA is being used. The number of bits used for the dynamic switch FDRA is therefore

$$max ( {log}_{2} ⌈ {N}_{RB - BWP} ( {N}_{RB - BWP} + 1 ) / 2 ⌉ , {N}_{RB - RBG} ) + 1 .$$

In unlicensed operation, the frequency resource of a BWP is divided into RB Sets, where each RB Set has a bandwidth of 20 MHz. The gNB can allocate one or more RB Sets for a UE, e.g. for a PUSCH transmission. Regulations for unlicensed operation require that an RB Set is entirely occupied, so that its energy can be detected by another device for LBT purposes.

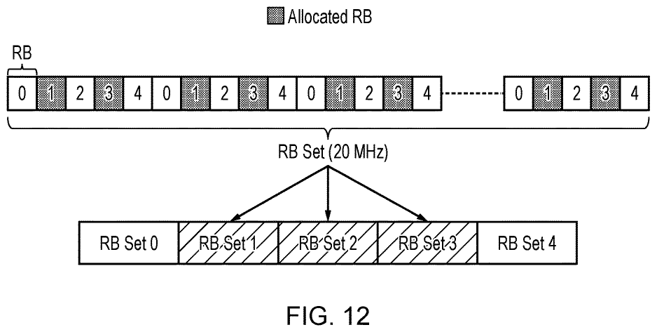

Type 2 FDRA is introduced for unlicensed operation to fulfil the unlicensed operation requirements, where in Type 2 FDRA, the RBs are allocated in an interlaced manner. M_{interlace}=either 10 or 5 interlace patterns, for 15 KHz and 30 KHz subcarrier spacing (SCS) respectively, are defined, where each interlaced pattern the allocated RBs start in a different RB offset followed by steps of M_{interlace} RBs. An example of a 30 KHz SCS interlaced allocation is shown in FIG. 12, where there M_{interlace}=5 patterns, numbered {0, 1, 2, 3, 4} in a RB Set of 20 MHz. The gNB can allocate a PUSCH to occupy one or more interlaced patterns. For example, in FIG. 12, interlaced patterns numbered 1 and 3 are allocated for a PUSCH. Once the interlaced patterns are allocated for an RB Set, the gNB can further allocate multiple RB Sets in the BWP, where the RB Sets are allocated by defining the starting RB Set and the number of contiguous RB Sets being allocated. In the example in FIG. 12, the gNB indicates RB Set 1 and 3 RB Sets, thereby allocating the PUSCH to occupy RB Set 1, RB Set 2 and RB Set 3 where in each RB Set interlaced pattern 1 and 3 are used.

The bit size of the FDRA field for Type 2 is

$${X}_{interlace} + {log}_{2} ⌈ \frac{{N}_{RB \_ Set} ( {N}_{RB \_ Set} + 1 )}{2} ⌉ ,$$

where N_{RB_Set} is the number of RB Sets in the BWP and X_{interlace}=6 and 5, for 15 kHz and 30 KHz SCS respectively, indicating the allocated interlaced pattern(s).

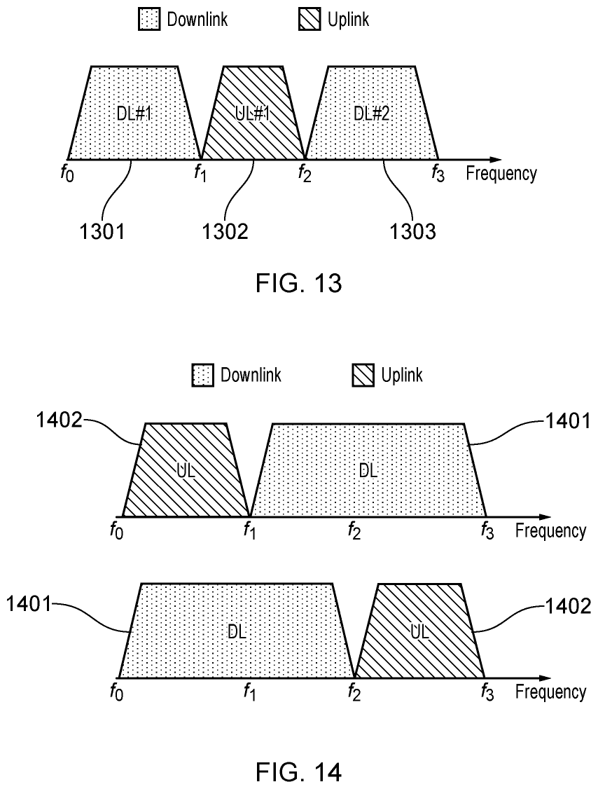

Two frequency configurations being considered for sub-bands are 2 DL+1 UL and 1 DL+1 UL as shown in FIG. 13 and FIG. 14 respectively. Those skilled in the art would appreciate however that such configurations as exemplified in FIGS. 13 and 14 are just two examples, and that any possible configuration could be used, with one or more DL sub-bands and one or more UL sub-bands arranged in any conceivable pattern.

The 2 DL+1 UL configuration consists of 2 DL sub-bands 1301, 1303 where the UL sub-band 1302 is in the middle, i.e. between the two DL sub-bands as shown ion FIG. 13. The 1 DL+1 UL configuration consists of one DL sub-band 1401 and one UL sub-band 1402 as shown in FIG. 14. For the 1 DL+1 UL sub-band configuration, the UL sub-band 1402 can start at the lower end of frequency bandwidth (e.g. starts at f₀) and end in the middle of the bandwidth (i.e. f₁) as shown in the top configuration of FIG. 14 followed by the DL sub-band 1401, or the UL sub-band 1402 can start in the middle of the bandwidth (i.e. at f₂) and end at the higher edge of the frequency bandwidth (at f₃) as shown in the lower configuration of FIG. 14, after the DL sub-band 1401.

For Type 0 and Type 1 FDRA, the bit size of the FDRA field is proportional to the number of RBs in the BWP, N_{RB-BWP}. However, in SBFD operation, only a portion of the BWP is used for either PDSCH or PUSCH, which means some of the FDRA bits are redundant. Furthermore, for the 2 DL+1 UL sub-band configuration as shown in FIG. 13 (or indeed any SBFD configuration having more than one DL and/or UL sub-bands positioned non-contiguously), a discontinuous PDSCH allocation such as Type 0 is required if the two DL sub-bands need to be allocated for a UE. This is because Type 1 allocation would be limited to only one of the DL sub-bands, due to it not being possible for Type 1 allocations to be discontinuous. It should be noted here that for Configuration 1 of Type 0 (with reference to Table I above) which offers a finer RBG granularity, Type 0 FDRA uses more bits than Type 1 which makes it ineffective. If Type 2 FDRA were to be considered, the same issues of a large number of bits being used would be true, hence making it ineffective too. Furthermore, Type 0 is not available for fallback DCI, i.e. DCI Format 0_0 and 1_0 for UL Grant and DL Grant respectively, which is a DCI (which may be used for purposes such as initial access) with a relatively small number of bits and thus for which a Type 0 FDRA may be too coarse. Hence a new FDRA method is required that is suitable for SBFD operation.

Embodiments of the present technique therefore seek to provide solutions to address such issues to provide improved resource allocation. For example, new FDRA methods which are effective and suitable for SBFD operation are proposed.

### FDRA Based on Subband Size

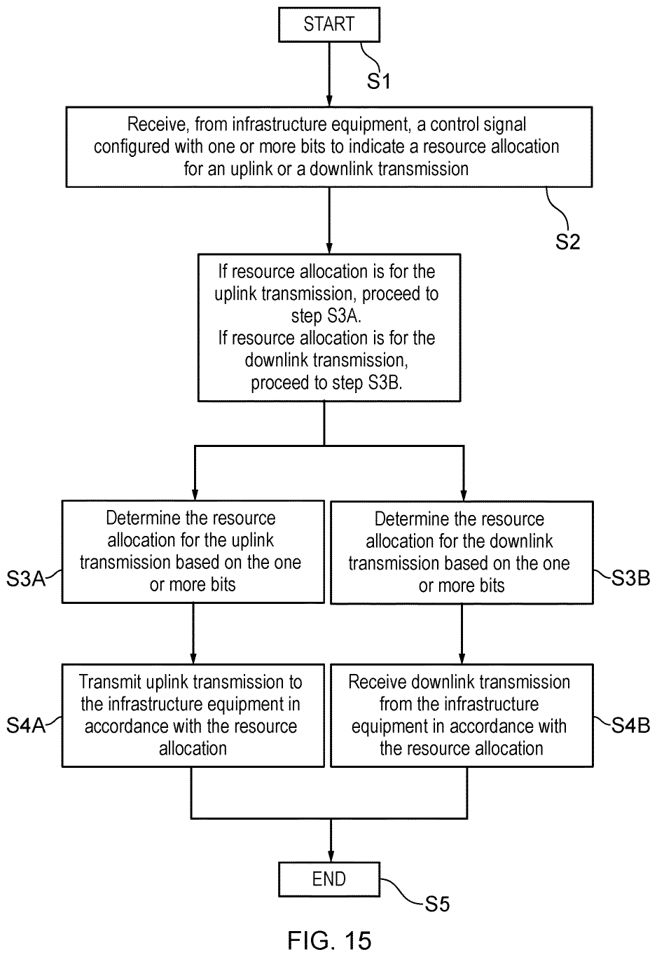

FIG. 15 is a flow diagram is a flow diagram illustrating a method of operating a communications device (such as a UE) in accordance with example embodiments.

The method begins in step S1.

The method comprises, in step S2, receiving, from infrastructure equipment of a wireless communications network, a control signal configured with one or more bits to indicate a resource allocation for transmitting an uplink transmission to the infrastructure equipment or receiving a downlink transmission from the infrastructure equipment within a set of contiguous resource units of a wireless radio interface. The set of contiguous resource units comprises one or more uplink frequency sets each comprising a plurality of uplink resource units and one or more downlink frequency sets each comprising a plurality of downlink resource units. The resource allocation comprises at least one of the uplink resource units in the one or more uplink frequency sets for the uplink transmission or at least one of the downlink resource units in the one or more downlink frequency sets for the downlink transmission.

The control signal is configured with the one or more bits to indicate the resource allocation for the uplink transmission based on a total number of the uplink resource units in the one or more uplink frequency sets. Alternatively, the control signal is configured with the one or more bits to indicate the resource allocation for the downlink transmission based on a total number of the downlink resource units in the one or more downlink frequency sets.

If the resource allocation is for the uplink transmission, then the method proceeds to step 3A.

In step S3A, the method comprises determining the resource allocation for the uplink transmission based on the one or more bits.

In step S4A, the method comprises transmitting the uplink transmission to the infrastructure equipment in accordance with the resource allocation.

Alternatively, if the resource allocation is for the downlink transmission, then the method proceeds to step 3B.

In step S3B, the method comprises determining the resource allocation for the downlink transmission based on the one or more bits.

In step S4B, the method comprises receiving the downlink transmission from the infrastructure equipment in accordance with the resource allocation.

The method ends in step S5.

Those skilled in the art would appreciate that the method shown by FIG. 15 may be adapted in accordance with embodiments of the present technique. For example, other intermediate steps may be included in this method, or the steps may be performed in any logical order.

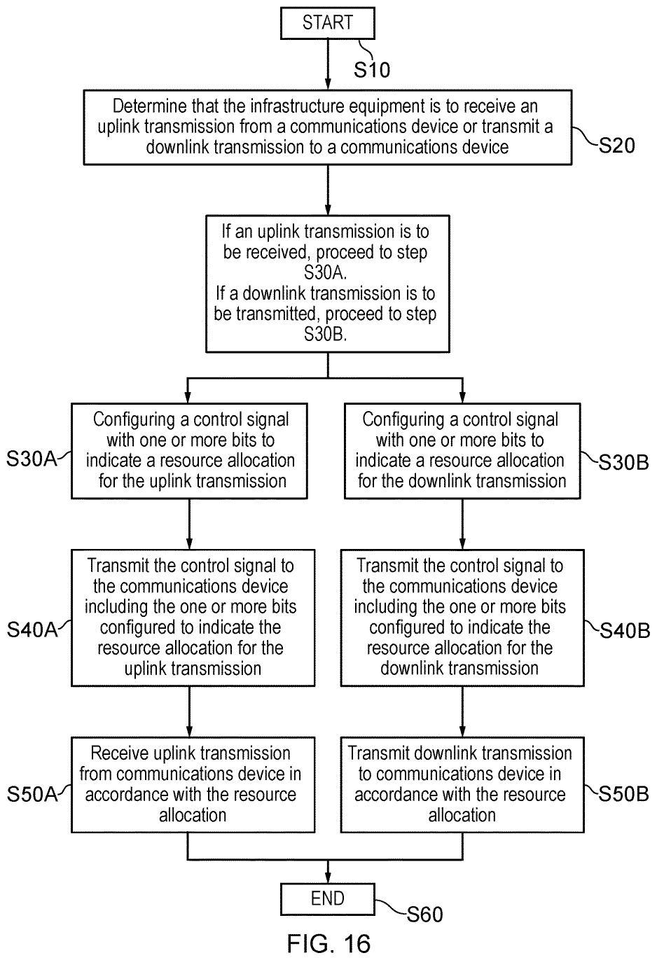

FIG. 16 is a flow diagram illustrating a method of operating infrastructure equipment (such as a gNB) of a wireless communications network in accordance with example embodiments.

The method begins in step S10.

In step S20, the method comprises determining that the infrastructure equipment is either to receive an uplink transmission from a communications device or to transmit a downlink transmission to the communications device within a set of contiguous resource units of a wireless radio interface. The set of contiguous resource units comprises one or more uplink frequency sets each comprising a plurality of uplink resource units and one or more downlink frequency sets each comprising a plurality of downlink resource units.

If infrastructure equipment determines in step S20 that it is to receive an uplink transmission from the communications device, then the method proceeds to step S30A.

In step S30A, the method comprises configuring a control signal with one or more bits to indicate a resource allocation for the uplink transmission comprising at least one of the uplink resource units in the one or more uplink frequency sets. The control signal is configured with the one or more bits to indicate the resource allocation for the uplink transmission based on a total number of the uplink resource units in the one or more uplink frequency sets.

In step 40A, the method comprises transmitting, to the communications device, the control signal including the one or more bits configured to indicate the resource allocation for the uplink transmission.

In step 50A, the method comprises receiving the uplink transmission from the communications device in accordance with the resource allocation.

Alternatively, if the infrastructure equipment determines in step S20 that it is to receive a downlink transmission from the communications device, then the method proceeds to step S30B.

In step S30B, the method comprises configuring a control signal with one or more bits to indicate a resource allocation for the downlink transmission comprising at least one of the downlink resource units in the one or more downlink frequency sets. The control signal is configured with the one or more bits to indicate the resource allocation for the downlink transmission based on a total number of the downlink resource units in the one or more downlink frequency sets.

In step 40B, the method comprises transmitting, to the communications device, the control signal including the one or more bits configured to indicate the resource allocation for the downlink transmission.

In step 50B, the method comprises transmitting the downlink transmission to the communications device in accordance with the resource allocation.

The method ends in step 60.

Those skilled in the art would appreciate that the method shown by FIG. 16 may be adapted in accordance with embodiments of the present technique. For example, other intermediate steps may be included in this method, or the steps may be performed in any logical order.

As will be appreciated from an understanding of example embodiments explained below, the methods described with reference to Figurers 15 and 16 can provide improved allocation of resources. For example, by configuring a control signal with one or more bits based on a total number of uplink or downlink units in the uplink or downlink frequency sets respectively, a reduced number of bits are required to indicate a resource allocation for an uplink or downlink transmission or an increased granularity of resource allocation can be provided for the same number of bits. Example embodiments can therefore take SBFD configuration into account when performing resource allocation.

In some embodiments, the control signal comprises downlink control information (DCI) and the one or more bits may belong to an FDRA field of the DCI. In such embodiments, FDRA may be referred to as “SBFD based FDRA”. In such embodiments, the DCI may carry the resource allocation for the uplink transmission (such as a UL grant) or the downlink transmission (such as a DL grant). Although example embodiments will be described below for the purposes of clarity in terms of bits in an FDRA field and DCI, it will be appreciated that any control signal which is configured with one or more bits to indicate the resource allocation can be used, e.g. activation DCI for SPS PDSCH or CG-PUSCH.

In some embodiments, the set of contiguous resource blocks may be a BWP. In such embodiments, the uplink/downlink frequency resource sets may be uplink/frequency subbands respectively. In such embodiments, the uplink/downlink resource units may be uplink/downlink resource blocks or uplink/downlink resource elements. Furthermore, in such embodiments, the at least one uplink/downlink resource unit in the resource allocation may be one or more uplink/downlink resource blocks or one or more uplink/downlink resource block groups. Although example embodiments will be described below for the purposes of clarity in terms of a wireless radio interface configured with BWPs, UL/DL subbands, UL/DL resource blocks and UL/DL resource block groups, it will be appreciated by one skilled in the art that example embodiments are applicable to any wireless radio interface comprising a set of contiguous resource units including one or more uplink frequency sets each comprising a plurality of uplink resource units and one or more downlink frequency sets each comprising a plurality of downlink resource units.

In some embodiments, a RNTI for a DCI includes an indication that the one or more bits of the DCI have been configured to indicate that the resource allocation for the uplink transmission is based on the total number of the uplink resource units in the one or more uplink frequency sets or that the resource allocation for the downlink transmission is based on the total number of the downlink resource units in the one or more downlink frequency sets. For example, a DCI carrying a DL grant or UL grant using an SBFD based FDRA may use a different RNTI to a DCI carrying a DL Grant or UL Grant for a non-SBFD (i.e. legacy TDD) based FDRA.

In some embodiments, one or more other bits in the DCI indicate that the resource allocation for the uplink transmission is based on the total number of the uplink resource units in the one or more uplink frequency sets or that the resource allocation for the downlink transmission is based on the total number of the downlink resource units in the one or more downlink frequency sets. For example, a 1-bit field (or repurposed bits) are introduced into the DCI carrying the DL Grant or UL Grant using a SBFD based FDRA to differentiate it from the DCI carrying DL Grant or UL Grant for a non-SBFD (i.e. legacy TDD) based FDRA.

In some embodiments, the DCI is transmitted according to a search space and/or a control resource set, CORESET, and the search space and/or CORSET indicates that the resource allocation for the uplink transmission is based on the total number of the uplink resource units in the one or more uplink frequency sets or that the resource allocation for the downlink transmission is based on the total number of the downlink resource units in the one or more downlink frequency sets. For example, the search space and/or the CORESET on which the DCI carrying DL Grant or UL Grant using a SBFD based FDRA is transmitted is different from the search space and/or the CORESET on which the DCI carrying DL Grant or UL Grant for a non-SBFD based FDRA (i.e. legacy TDD) is transmitted.

In some embodiments, the configuring of the control signal with the one or more bits to indicate the resource allocation comprises determining a number of bits to include in the control signal based on the total number of uplink resource units in the one or more uplink frequency sets if the resource allocation is for the uplink transmission, or based on the total number of downlink resource units in the one or more downlink frequency sets if the resource allocation is for the downlink transmission. In some embodiments, the greater the total number of uplink resource units in the one or more uplink frequency sets, the greater the number of bits included in the control signal to indicate the uplink resource allocation. In some embodiments, the greater the total number of downlink resource units in the one or more downlink frequency sets, the greater the number of bits included in the control signal to indicate the downlink resource allocation. In other words, the number of bits included in the control signal may be proportional to the total number of uplink or downlink resource units in the one or more uplink or downlink frequency sets. For example, if a DCI is allocating a DL transmission then a bit size of an FDRA field of the DCI is proportional to the total number of RBs in the DL subbands of a BWP. Alternatively, if a DCI is allocating a UL transmission then a bit size of an FDRA field of the DCI is proportional to the total number of RBs in the UL subbands of a BWP. The subband configuration (that is, the location and size of the UL/DL subbands) may be semi-statically configured. Therefore, the FDRA bit size may also be semi-statically configured in the DCI.

In some embodiments, the FDRA field in the DCI is a Type 0 FDRA field. In some embodiments, the granularity of an RBG for the UL and DL subband is the same but the number of RBGs in the UL and DL subband depend on the size of the UL and DL subband respectively. As mentioned previously, the granularity of an RBG may alternatively be referred to as the number of RBs in an RBG. For example:
a total number of RBs in a BWP (N_{RB-BWP}) is determined,
a granularity of an RBG (N_{RB-RBG}) is determined using N_{RB-BWP} e.g. from Table 1,
a total number of RBGs in the BWP (N_{RBG-BWP}) is determined using: N_{RBG-BWP}=ceil (N_{RB-BWP}/N_{RB-RBG}).
The RBGs in the BWP are divided into the DL and UL (N_{RBG-UL}) subbands proportionally based on their respective sizes. For example, a total number of RBs across all the DL subbands in the BWP (N_{RB-DL}) is determined, and the total number of RBGs for the DL subbands (N_{RGB-DL}) is determined according to: (N_{RGB-DL})=(N_{RB-DL}/N_{RB-BWP})*(N_{RBG-BWP}). Similarly, a total number of RBs across all the UL subbands in the BWP (N_{RB-UL}) is determined, and the total number of RBGs for the UL subbands (N_{RGB-UL}) is determined according to: (N_{RGB-UL})=(N_{RB-UL}/N_{RB-BWP})*(N_{RBG-BWP}).

As mentioned previously, in Type 0 FDRA, each bit in the FDRA field indicates one RBG. Conventional FDRA fields comprise a bitmap with a number of bits equal to the total number of RBGs in a BWP and each bit indicates whether or not one of the RGBs in the BWP is allocated with resources. However, as mentioned above, when resource allocation is performed for a BWP which is divided into UL and DL subbands, a number of the bits become redundant. For example, when the FDRA field allocates a UL transmission, only RBGs in the UL subband will be allocated with resources. Despite this, conventional FDRA fields include a number of bits to explicitly indicate that the RBGs in the DL subbands are not allocated with resources. This is an efficient use of bits in the FDRA field. By contrast, the method described above divides the number of RBGs in the UL and DL subband proportionally according to their respective size. Then, for an uplink transmission, the DCI can be configured with N_{RGB-UL} bits in the FDRA field with each bit indicating whether or not one of the RBGs in the UL subbands have been allocated with resources or not. Alternatively, for a DL transmission, the DCI can be configured with N_{RGB-DL} bits in the FDRA field with each bit indicating whether or not one of the RBGs in the DL subbands have been allocated with resources or not. In both cases, since N_{RGB-UL} and N_{RGB-DL} are less than N_{RBG-BWP}, the number of bits required to allocate resources for an uplink or a downlink transmission is decreased.

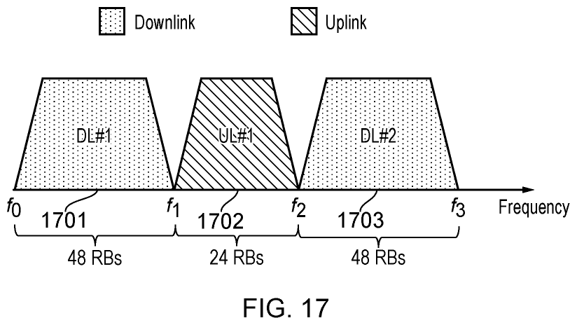

An example is shown in FIG. 17, where a 2 DL+1 UL subband is configured in a BWP with 120 RBs. Therefore N_{RB-BWP}=120 RBs. The total DL subband size, N_{RB-DL}, is 2×48=96 RBs and the total UL subband size, N_{RB-UL}, is 24 RBs. Since N_{RB-BWP}=120 RBs, then N_{RB-RBG}=8 RBs according to Table 1 (using configuration 1). Therefore, the total number of RBGs in the BWP is determined according to N_{RBG-BWP}=N_{RB-BWP}/N_{RB-RBG}=120/8=15. Therefore, the total number of RBGs in the DL subbands (N_{RGB-DL}) is determined according to N_{RGB-DL}=(N_{RB-DL}/N_{RB-BWP})*(N_{RBG-BWP})=(96/120)*(15)=12 and the total number of RBGs in the UL subband (N_{RGB-UL}) is determined according to N_{RGB-UL}=(N_{RB-UL}/N_{RB-BWP})*(N_{RBG-BWP})=(24/120)*(15)=3. Therefore, an FDRA field indicating a resource allocation for a DL transmission only requires 12 bits while a resource allocation for a UL transmission only requires 3 bits. A conventional FDRA field would require 15 bits to indicate a resource allocation for either a UL or DL transmission.

In some embodiments, for Type 0 FDRA, the granularity of the RBGs in the UL subband (i.e. the number for RBs in an RBG for the UL subband) and the granularity of the DL subband (i.e. the number for RBs in an RBG for the DL subbands) depend on the respective size of the UL and DL subbands. For example:
a total number of RBs across all the DL subbands in the BWP (N_{RB-DL}) is determined and a total number of RBs across all the UL subbands in the BWP (N_{RB-UL}) is determined,
using Table 1 and N_{RB-DL} in place of N_{RB-BWP}, a granularity of an RBG for the DL subbands (N_{RB-RBG-DL}) is determined and, using Table 1 and N_{RB-UL} in place of N_{RB-BWP}, a granularity of an RBG for the UL subbands (N_{RB-RBG-UL}) is determined.
The total number of RBGs in the DL subbands (N_{RBG-DL}) is determined according to N_{RBG-DL}=N_{RB-DL}/N_{RB-RBG-DL} and the total number of RBGs in the UL subbands (N_{RBG-UL}) is determined according to N_{RBG-UL}=N_{RB-UL}/N_{RB-RBG-UL}

By using N_{RB-DL} in place of N_{RB-BWP} and N_{RB-UL} in place of N_{RB-BWP} with Table 1, a granularity can be determined which is different for the UL subbands and the DL subbands. This can provide finer RBG granularity as compared with conventional FDRA fields which can improve gNB scheduling flexibility.

An example is shown in FIG. 17, where a 2 DL+1 UL subband is configured in a BWP with 120 RBs. The total DL subband size, N_{RB-DL}, is 2×48=96 RBs and the total UL subband size, N_{RB-UL}, is 24 RBs. Using N_{RB-DL} and Table 1, the granularity of an RBG for the DL subbands N_{RB-RBG-DL}=8 RBs (using configuration 1). Using N_{RB-UL} and Table 1, the granularity of an RBG for the UL subband N_{RB-RBG-UL}=2 RBs (using configuration 1). Therefore, the total number of RBGs in the DL subbands N_{RBG-DL}=96/8=12 RBGs and the total number of RBGs in the UL subband N_{RB-RBG-UL}=24/2=12 RGBs. Although, in this example, the number of RBGs for the DL subbands and for the UL subband is the same, they need not be the same. Accordingly, the number of bits used to indicate a resource allocation for a downlink or an uplink transmission is the same. However, the granularity of the resource allocation for the uplink transmission is higher, providing increased gNB scheduling flexibility.

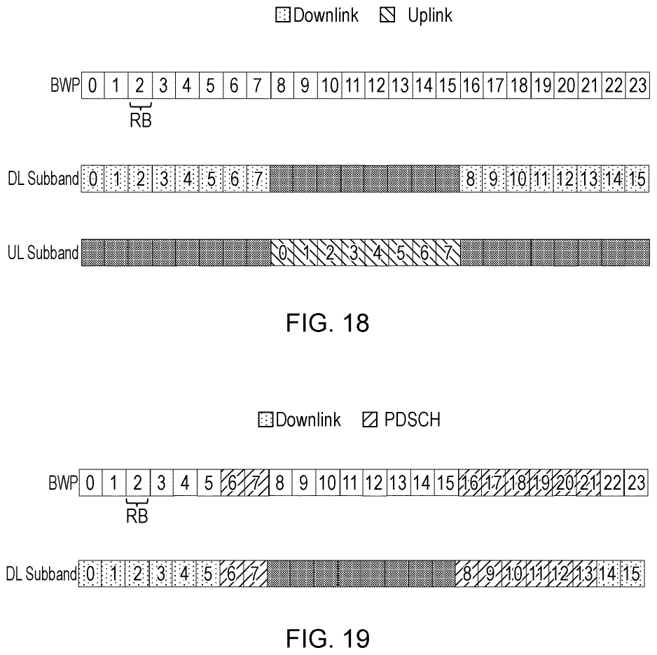

In some embodiments, a subband RB indexing is used to be the reference of the RBs used for FDRA, instead of the legacy RB indexing used in a BWP. The subband RB indexing includes only RBs in a group of DL or UL subbands. An example is shown in FIG. 18, where an index for a BWP comprises 24 entries each identifying one of the RBs in the BWP as {0, 1, 2, . . . , 23}. In this example, the BWP is configured with a 2 DL+1 UL subband configuration, where each subband includes 8 RBs. Two groups of subbands are formed where first group comprises the 2 DL subbands and the second group comprises the 1 UL subband. For the first group, only the 16 RBs in the 2 DL subbands are indexed. As shown in FIG. 18, a DL sub-index for the 2 DL subbands comprises 16 entries each identifying one of the RBs in the DL subbands as {0, 1, 2, . . . , 15}. Similarly for the 2nd group, only the 8 RBs in the UL subband are indexed. As shown in FIG. 18, a UL sub-index for the UL subband comprises 8 entries each identifying one of the RBs in the UL subband as {0, 1, 2, . . . , 7}. By using subband RB indexing, the legacy Type 0 and Type 1 FDRA can be reused but with an FDRA bit size according to the total number of RBs in the grouped subbands. For example, for DL Grant, a Type 1 FDRA can be used with N_{DL-bits}=log₂┌N_{RB-DL} (N_{RB-DL}+1)/2┐. In this example, there are 2 DL subbands each including 8 RBs. Therefore N_{RB-DL}=2(8)=16 RBs. Accordingly, N_{DL-bits}=log₂┌16(16+1)/2┐=8 bits. The bits in the Type 1 FDRA can indicate a starting RB of 6 with length of 8 RBs for a PDSCH. As shown in FIG. 19, the bits in a Type 1 FDRA are configured to indicate entries {6, 7, 8, 9, 10, 11, 12, 13} of the DL sub-index for the DL subbands for transmitting PDSCH. In another example, for UL Grant, a Type 1 FDRA can be used with N_{UL-bits}=log₂┌N_{RB-UL}(N_{RB-UL}+1)/2┐. In this example, there is 1 UL subband including 8 RBs. Therefore N_{RB-UL}=8 RBs. Accordingly, N_{UL-bits}=log₂┌8(8+1)/2┐=6 bits. As shown in FIG. 19, entries {6, 7, 8, 9, 10, 11, 12, 13} of the DL sub-index for the DL subbands occupy equivalent BWP RB entries {6, 7, 16, 17, 18, 19, 20, 21}. Although the example described above describes the forming of two groups where one group includes all the DL subbands of the BWP and the other group includes all the UL subbands of BWP, it should be appreciated that each group may correspond to a sub-set of the DL subbands or the UL subbands. For example, if a BWP comprises 4 DL subbands, then a subband group may be configured to consist of only 2 DL subbands.

In some embodiments, the subbands grouped for subband RB indexing is semi-statically configured or fixed in the specifications.

In some embodiments, the subbands grouped for subband RB indexing is dynamically enabled or disabled, for example, 1-bit field included in the DCI.

Although example embodiments have been described above with reference to a 2 DL+1 UL subband configuration, it will be appreciated that the present disclosure applies equally to any SBFD configuration comprising one or more DL subbands and one or more UL subbands.

### Subband Mask

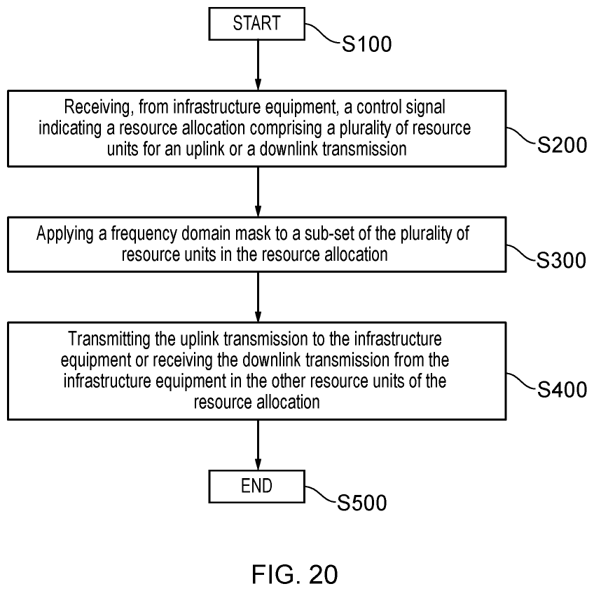

FIG. 20 is a flow diagram illustrating a method of operating a communications device (such as a UE) in accordance with example embodiments.

The method starts in step S100.

In step S200, the method comprises receiving, from infrastructure equipment of a wireless communications network, a control signal indicating a resource allocation for transmitting an uplink transmission to the infrastructure equipment or receiving a downlink transmission from the infrastructure equipment within a set of contiguous resource units of a wireless radio interface. The resource allocation comprises a plurality of the resource units in the contiguous set of resource units for the uplink transmission or the downlink transmission.

In step S300, the method comprises applying a frequency domain mask to a sub-set of the plurality of resource units in the resource allocation. The frequency domain mask disables the sub-set of the plurality of resource units in the resource allocation for transmitting the uplink transmission or receiving the downlink transmission.

In step S400, the method comprises transmitting the uplink transmission to the infrastructure equipment, or receiving the downlink transmission from the infrastructure equipment, in the other resource units in the resource allocation to which the frequency domain mask was not applied.

In step S500, the method ends.

Those skilled in the art would appreciate that the method shown by FIG. 20 may be adapted in accordance with embodiments of the present technique. For example, other intermediate steps may be included in this method, or the steps may be performed in any logical order.

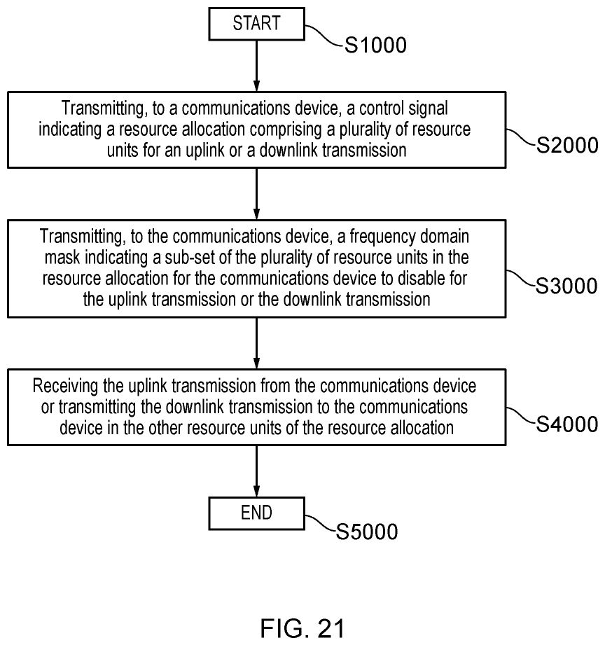

FIG. 21 shows a flow diagram illustrating an example process of communications in a communications system in accordance with embodiments of the present technique. The process shown by FIG. 21 is a method of operating infrastructure equipment (such as a gNB) of a wireless communications network.

The method starts in step S1000.

In step S2000, the method comprises transmitting, to a communications device, a control signal indicating a resource allocation for receiving an uplink transmission from the communications device or transmitting a downlink transmission to the communications device within a set of contiguous resource units of a wireless radio interface. The resource allocation comprises a plurality of the resource units in the contiguous set of resource units for the uplink transmission or the downlink transmission.

In step S3000, the method comprises transmitting, to the communications device, a frequency domain mask indicating a sub-set of the plurality of resource units in the resource allocation for the communications device to disable for the uplink transmission or the downlink transmission.

In step 4000, the method comprises receiving the uplink transmission from the communications device, or transmitting the downlink transmission to the communications device, in the other resource units in the resource allocation which were not indicated by the frequency domain mask.

In step S5000, the method ends.

Those skilled in the art would appreciate that the method shown by FIG. 21 may be adapted in accordance with embodiments of the present technique. For example, other intermediate steps may be included in this method, or the steps may be performed in any logical order.

As will be appreciated from an understanding of example embodiments explained below, the methods described with reference to FIGS. 20 and 21 can provide improved allocation of resources. For example, the use of a frequency domain mask to disable resource units for transmission or reception can enable discontinuous Type 1 FDRA resource allocation. Therefore, the granularity of Type 1 FDRA resource allocation can be achieved but with improved scheduling flexibility.

In some embodiments, a Frequency Domain Mask (FD Mask) is applied to the BWP where a scheduled transmission such as PDSCH/PUSCH/PUCCH. The scheduled transmission may rate match around the masked resource units or puncture the masked resource units. In embodiments where the resource units are resource elements (REs), the scheduled transmission may rate match around the masked REs or puncture the masked REs. In embodiments where the resource units are resource blocks (RBs), the scheduled transmission may rate match around the masked RBs or puncture the masked RBs.

In rate matching, the transport channel processing adapts to the number of REs after the masked REs are taken out and the RE mappings would map the encoded symbols to avoid the masked REs. In puncturing the physical channel processing would avoid the masked REs by puncturing the modulated symbols that are mapped to the masked REs. For example, 100 information bits is scheduled to occupy 150 REs. Here the MCS used is to QPSK and ⅓ code rate, and if there is no masking, i.e. all 150 REs are used, then the transport channel processing would produce 300 encoded bits, which is then modulated to 150 QPSK symbols and maps to the 150 REs. If 50 REs are masked, i.e. 100 REs out of 150 REs are available, then:
In rate matching, the transport channel processing will produce 200 encoded bits which are then QPSK modulated to 100 symbols. These are then RE mapped to the 100 available REs.
In puncturing, the transport channel processing still produces 300 encoded bits, which are modulated to 150 QPSK symbols and RE maps to the 150 REs. The masked REs are then punctured, i.e. removed, thereby resulting in 100 REs being transmitted.

Although the above description of rate matching and puncturing is explained in terms of RES, it will be appreciated that the above description applies more generally to other resource units (such as RBs) because, as explained above, an RE is merely one example of a resource unit.

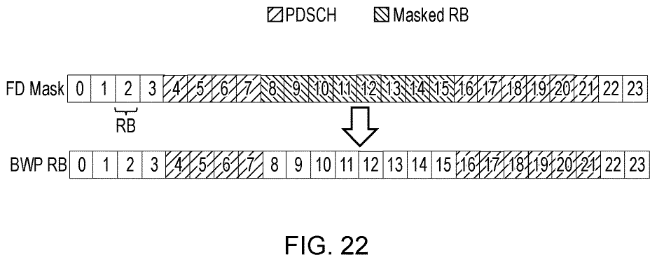

An FD mask may be alternatively referred to as a Subband Mask. An example is shown in FIG. 22. As shown in FIG. 22, an index for a BWP comprises 24 entries each identifying an RB in the BWP as {0, 1, 2, 3, . . . , 23}. Furthermore, an FD mask has been applied to a subset of the RBs in the BWP, i.e. entries {8, 9, 10, 11, 12, 13, 14, 15}. The entries to which the FD mask has been applied may be referred to as having been “masked out” or disabled/excluded for a transmission or reception.

A DL Grant scheduling a PDSCH for a UE has a Type 1 FDRA that starts at RB=4 and has a length of 18 RBs. Therefore, the PDSCH is scheduled to occupy RB {4, 5, 6, . . . , 21}. In accordance with example embodiments, the UE applies the FD Mask and rate matches around the masked RBs resulting in the PDSCH occupying 10 RBs, i.e. {4, 5, 6, 7, 16, 17, 18, 19, 20, 21}. This FD Mask therefore enables Type 1 FDRA to schedule discontinuous RBs for a PDSCH/PUSCH/PUCCH. The UE is aware of the size and location of the masked resources. The mask can therefore be used to mask out subbands, e.g. guard subbands, UL subband(s) when performing DL receptions or DL subband(s) when performing UL transmissions. In such cases, inter symbol interference (ISI) and/or cross link interference (CLI) can be alleviated because situations in which simultaneous uplink/downlink transmissions occur on overlapping resources can be avoided.

In some embodiments, the FD mask can be semi-statically configured or fixed in the specifications. A separate FD Masks can be configured/defined for DL transmission and UL transmission.

In some embodiments, the said frequency domain mask can be dynamically enabled or activated. In other words, the FD mask may be semi-statically configured but a subsequent DCI is used to dynamically indicate to the UE whether or not to apply the configured FD mask. The activation may be in a semi-persistent manner. For example, once a configured FD mask is activated by the DCI, the FD mask is applied until deactivated. In another example, the activation of the configured FD mask may be aperiodic. In other words, the configured FD mask applies only once. For example, if a DL grant activates the configured FD mask, then the configured FD mask is applicable only once for the PDSCH scheduled by that DL grant.

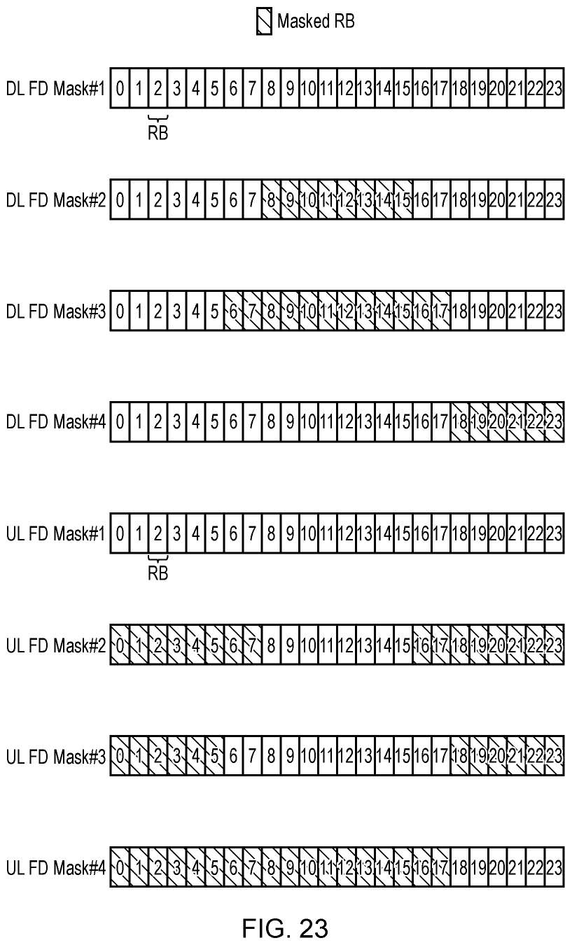

In some embodiments, a gNB can configure multiple FD masks for a UE. The gNB may semi-statically configure a set of FD Masks for DL transmissions and another set of FD Masks for UL transmissions. The gNB may then dynamically indicate one of the configured FD Masks to be used in a DL or UL transmission using a new FD Mask field in the DCI. Different BWP may have different FD Masks configurations and the number of FD Masks in different BWP may also be different since each BWP can have different sizes. As will be appreciated, such embodiments are especially advantageous if the gNB desires to implement a dynamic subband, i.e. the subband configuration can be dynamically changed. An example is shown in FIG. 23, where eight FD Masks are configured for a UE in a particular BWP with a size of 24 RBs. A set of FD Masks is configured for DL transmissions (labelled as DL FD Mask #1, DL FD Mask #2, DL FD Mask #3 & DL FD Mask #4) and another set of FD Masks is configured for UL transmissions (labelled as UL FD Mask #1, UL FD Mask #2, UL FD Mask #3 & UL FD Mask #4). The DL Grant and UL Grant DCIs are configured with a 2-bit FD Mask field to indicate one of 4 FD Masks to use. In this example, the first FD Mask for DL and UL do not have any masked RB, which can be used to indirectly disable the FD Mask or indicate that there is no SBFD operation in the PDSCH/PUSCH/PUCCH allocation. The different FD Masks can be used for dynamic subband configuration. For example, DL FD Mask #2 can be used for a 2 DL+1 UL subband configuration where each subband is 8 RBs wide and FD Mask #4 can be used for 1 DL+1 UL subband configuration. In some examples, DL FD Mask #2 and DL FD Mask #3 can be used by the gNB to schedule a PDSCH to use discontinuous RBs using legacy Type 1 FDRA. It will be appreciated that other FD Masks configurations can be configured and different number of FD Masks to the example in FIG. 23 can be used.

The following numbered paragraphs provide further example aspects and features of the present technique:

Paragraph 1. A method of operating communications device, the method comprising
receiving, from infrastructure equipment of a wireless communications network, a control signal configured with one or more bits to indicate a resource allocation for transmitting an uplink transmission to the infrastructure equipment or receiving a downlink transmission from the infrastructure equipment within a set of contiguous resource units of a wireless radio interface, wherein the set of contiguous resource units comprises one or more uplink frequency sets each comprising a plurality of uplink resource units and one or more downlink frequency sets each comprising a plurality of downlink resource units, the resource allocation comprising at least one of the uplink resource units in the one or more uplink frequency sets for the uplink transmission or at least one of the downlink resource units in the one or more downlink frequency sets for the downlink transmission, and wherein
the control signal is configured with the one or more bits to either
indicate the resource allocation for the uplink transmission based on a total number of the uplink resource units in the one or more uplink frequency sets, or
indicate the resource allocation for the downlink transmission based on a total number of the downlink resource units in the one or more downlink frequency sets, and the method comprises
determining the resource allocation for the uplink or the downlink transmission based on the one or more bits,
transmitting the uplink transmission to the infrastructure equipment or receiving the downlink transmission from the infrastructure equipment in accordance with the resource allocation.

Paragraph 2. A method according to paragraph 1, wherein a number of the bits included in the control signal is based on the total number of uplink resource units in the one or more uplink frequency sets if the resource allocation is for the uplink transmission, or based on the total number of downlink resource units in the one or more downlink frequency sets if the resource allocation is for the downlink transmission.

Paragraph 3. A method according to paragraph 2, wherein the number of bits included in the control signal is proportional to the total number of uplink resource units in the one or more sets of uplink frequency sets if the resource allocation is for the uplink transmission, or proportional to the total number of downlink resource units in the one or more sets of downlink frequency sets if the resource allocation is for the downlink transmission.

Paragraph 4. A method according to any of paragraphs 1 to 3, wherein
the plurality of uplink resource units in each of the one or more uplink frequency sets are grouped into one or more groups of contiguous uplink resource units based on the total number of the uplink resource units in the one or more uplink frequency sets, wherein the at least one uplink resource unit in the resource allocation comprises one or more of the groups and each bit is configured to indicate one of the groups in the resource allocation, or
the plurality of downlink resource units in each of the one or more downlink frequency sets are grouped into one or more groups of contiguous downlink resource units based on the total number of the downlink resource units in the one or more downlink frequency sets, wherein the at least one downlink resource unit in the resource allocation comprises one or more of the groups and each bit is configured to indicate one of the groups in the resource allocation, and
the determining the resource allocation for the uplink or the downlink transmission based on the one or more bits comprises determining the one or more groups in the resource allocation based on the one or more bits.

Paragraph 5. A method according to paragraph 4, wherein a number of the uplink or downlink resource units included in the each of the groups of contiguous uplink or downlink resource units is based on the total number of the uplink or downlink resource units in the one or more uplink or downlink frequency sets.

Paragraph 6. A method according to paragraph 4, wherein
a number of the uplink or downlink resource units included in each of the groups of contiguous uplink or downlink resources is based on a total number of the resource units in the set of contiguous resource units, and
a number of the groups of contiguous uplink or downlink resource units included in each of the uplink or downlink frequency sets is based on a proportion of the total number of uplink or downlink resource units in the one or more uplink or downlink frequency sets of the total number of the resource units in the set of contiguous resource units.

Paragraph 7. A method according to any of paragraphs 1 to 6, wherein the determining the resource allocation for the uplink or the downlink transmission based on the one or more bits comprises
determining, based on the one or more bits, a first uplink or downlink resource unit in the resource allocation, and
determining, based on the one or more bits, a number of uplink or downlink resource units in the resource allocation.

Paragraph 8. A method according to any of paragraphs 1 to 4, wherein
an index for the set of contiguous resource units comprises a plurality of entries each identifying one of the plurality of uplink or downlink resource units,
an uplink sub-index for one or more of the uplink frequency sets comprises the entries in the index which identify the uplink resource units in the one or more uplink frequency sets for the one or more of the uplink frequency sets,
a downlink sub-index for one or more of the downlink frequency sets comprises the entries in the index which identify the downlink resource units in the one or more downlink frequency sets for the one or more of the downlink frequency sets, wherein
if the resource allocation is for the uplink transmission,
receiving the uplink sub-index from the infrastructure equipment, and wherein the determining the resource allocation for the uplink transmission based on the one or more bits comprises
determining, based on the one or more bits, the entries of the uplink sub-index which identify the one or more uplink resource units comprised in the resource allocation, or
if the resource allocation is for the downlink transmission,
receiving the downlink sub-index from the infrastructure equipment, and wherein the
determining the resource allocation for the downlink transmission based on the one or more bits comprises determining, based on the one or more bits, the entries of the downlink sub-index which identify the one or more downlink resource units comprised in the resource allocation.

Paragraph 9. A method according to paragraph 8, comprising
receiving an activation indication from the infrastructure equipment to activate the uplink or downlink sub-index.

Paragraph 10. A method according to paragraph 9, wherein the activation indication is received in downlink control information, DCI.

Paragraph 11. A method according to any of paragraphs 1 to 10, wherein the set of contiguous resource units of the wireless access interface is a bandwidth part, BWP, of the wireless access interface.

Paragraph 12. A method according to any of paragraphs 1 to 11, wherein the control signal comprises downlink control information, DCI, and the one or more bits are one or more bits of the DCI.

Paragraph 13. A method according to paragraph 12, wherein the one or more bits are one or more bits of a frequency domain resource assignment, FDRA, field of the DCI.

Paragraph 14. A method according to paragraph 12 or paragraph 13, wherein the
determining the resource allocation for the downlink transmission based on the one or more bits comprises
determining, based on the DCI, a radio network terminal identifier, RNTI, for the DCI, determining, based on the determined RNTI, that the resource allocation for the uplink transmission is based on the total number of the uplink resource units in the one or more uplink frequency sets or that the resource allocation for the downlink transmission is based on the total number of the downlink resource units in the one or more downlink frequency sets.

Paragraph 15. A method according to any of paragraphs 12 to 13, comprising
determining, based one or more other bits of the DCI, that the resource allocation for the uplink transmission is based on the total number of the uplink resource units in the one or more uplink frequency sets or that the resource allocation for the downlink transmission is based on the total number of the downlink resource units in the one or more downlink frequency sets.

Paragraph 16. A method according to any of paragraphs 12 to 13, comprising
receiving the DCI according to a search space and/or a control resource set, CORESET,
determining, based on the search space and/or CORSET, that the resource allocation for the uplink transmission is based on the total number of the uplink resource units in the one or more uplink frequency sets or that the resource allocation for the downlink transmission is based on the total number of the downlink resource units in the one or more downlink frequency sets.

Paragraph 17. A method of operating infrastructure equipment of a wireless communications network, the method comprising
determining that the infrastructure equipment is either to receive an uplink transmission from a communications device or to transmit a downlink transmission to the communications device within a set of contiguous resource units of a wireless radio interface, wherein the set of contiguous resource units comprises one or more uplink frequency sets each comprising a plurality of uplink resource units and one or more downlink frequency sets each comprising a plurality of downlink resource units,
configuring a control signal with one or more bits to either
indicate a resource allocation for the uplink transmission comprising at least one of the uplink resource units in the one or more uplink frequency sets, wherein the control signal is configured with the one or more bits to indicate the resource allocation for the uplink transmission based on a total number of the uplink resource units in the one or more uplink frequency sets, or
indicate a resource allocation for the downlink transmission comprising at least one of the downlink resource units in the one or more downlink frequency sets, wherein the control signal is configured with the one or more bits to indicate the resource allocation for the downlink transmission based on a total number of the downlink resource units in the one or more downlink frequency sets, and the method comprises
transmitting, to the communications device, the control signal including the one or more bits configured to indicate the resource allocation for the uplink or the downlink transmission, and
receiving the uplink transmission from the communications device or transmitting the downlink transmission to the communications device in accordance with the resource allocation.

Paragraph 18. A method according to paragraph 17, wherein the configuring the control signal with the one or more bits to indicate the resource allocation comprises
determining a number of bits to include in the control signal to indicate the resource allocation based on the total number of uplink resource units in the one or more uplink frequency sets if the resource allocation is for the uplink transmission, or based on the total number of downlink resource units in the one or more downlink frequency sets if the resource allocation is for the downlink transmission.

Paragraph 19. A method according to paragraph 18, wherein the determined number of bits to include in the control signal is proportional to the total number of uplink resource units in the one or more sets of uplink frequency sets if the resource allocation is for the uplink transmission, or proportional to the total number of downlink resource units in the one or more sets of downlink frequency sets if the resource allocation is for the downlink transmission.

Paragraph 20. A method according to any of paragraphs 17 to 19, wherein the configuring the control signal with the one or more bits to indicate the resource allocation comprises
grouping the plurality of uplink resource units in each of the one or more uplink frequency sets into one or more groups of contiguous uplink resource units, the grouping being based on the total number of the uplink resource units in the one or more uplink frequency sets, the grouping comprising
determining a number of uplink resource units to include in each of the groups of contiguous uplink resource units, each of the groups including the same number of uplink resource units, and
determining a number of the groups to include in each of the uplink frequency sets, wherein the at least one uplink resource unit in the resource allocation comprises one or more of the groups and each of the one or more bits are configured to indicate one of the groups in the resource allocation, or
grouping the plurality of downlink resource units in each of the one or more downlink frequency sets into one or more groups of contiguous downlink resource units, the grouping being based on the total number of the downlink resource units in the one or more downlink frequency sets, the grouping comprising
determining a number of downlink resource units to include in each of the groups of contiguous downlink resource units, each of the groups including the same number of downlink resource units, and
determining a number of the groups to include in each of the downlink frequency sets, wherein the at least one downlink resource unit in the resource allocation comprises one or more of the groups and each of the one or more bits are configured to indicate one of the groups in the resource allocation.

Paragraph 21. A method according to paragraph 20, wherein the determining the number of uplink resource or downlink units to include in each of the groups of contiguous uplink or downlink resource units comprises
determining the number of uplink or downlink resource units to include in each of the groups of contiguous uplink or downlink resource units based on the total number of the uplink or downlink resource units in the one or more uplink or downlink frequency sets.

Paragraph 22. A method according to paragraph 20, wherein the determining the number of uplink or downlink resource units to include in each of the groups of contiguous uplink or downlink resource units comprises
determining the number of uplink or downlink resource units to include in each of the groups of contiguous uplink or downlink resource units based on a total number of the resource units in the set of contiguous resource units, wherein the determining the number of the groups to include in each of the uplink or downlink frequency sets comprises
determining a proportion of the total number of uplink or downlink resource units in the one or more uplink or downlink frequency sets of the total number of the resource units in the set of contiguous resource units,
determining the number of groups to include in each of the uplink or downlink frequency sets based on the determined proportion.

Paragraph 23. A method according to any of paragraphs 17 to 22, wherein the configuring the control signal with the one or more bits to indicate the resource allocation comprises
configuring the one or more bits to indicate
a first uplink or downlink resource unit in the resource allocation, and
a number of uplink or downlink resource units in the resource allocation.

Paragraph 24. A method according to any of paragraphs 17 to 23, wherein the configuring the control signal with the one or more bits to indicate the resource allocation comprises
determining an index for the set of contiguous resource units, the index for the set of contiguous resource units comprising a plurality of entries each identifying one of the plurality of uplink or downlink resource units, and
determining an uplink sub-index for one or more of the uplink frequency sets, the uplink sub-index comprising the entries in the index which identify the uplink resource units in the one or more uplink frequency sets for which the uplink sub-index is determined,
determining a downlink sub-index for one or more of the downlink frequency sets, the downlink sub-index comprising the entries in the index which identify the downlink resource units in the one or more downlink frequency sets for which the downlink sub-index is determined,
if the resource allocation is for the uplink transmission,
configuring the one or more bits to indicate the entries of the sub-index which identify the one or more uplink resource units comprised in the resource allocation, and
transmitting the uplink sub-index to the communications device, or
if the resource allocation is for the downlink transmission,
configuring the one or more bits to indicate the entries of the sub-index which identify the one or more downlink resource units comprised in the resource allocation, and
transmitting the downlink sub-index to the communications device.

Paragraph 25. A method according to paragraph 24, comprising
transmitting an activation indication to the communications device to activate the uplink or downlink sub-index.

Paragraph 26. A method according to paragraph 25, wherein the activation indication is transmitted in downlink control information, DCI.

Paragraph 27. A method according to any of paragraphs 17 to 26, wherein the set of contiguous resource units of the wireless access interface is a bandwidth part, BWP, of the wireless access interface.

Paragraph 28. A method according to any of paragraphs 17 to 27, wherein the configuring the control signal with one or more bits to indicate the resource allocation comprises
configuring one or more bits of downlink control information, DCI, to indicate the resource allocation.

Paragraph 29. A method according to paragraph 28, wherein the configuring the one or more bits of DCI to indicate the resource allocation comprises
configuring one or more bits of a frequency domain resource assignment, FDRA, field of the DCI to indicate the resource allocation.

Paragraph 30. A method according to paragraph 28 or paragraph 29, wherein the configuring the one or more bits of the DCI to indicate the resource allocation comprises
determining a radio network terminal identifier, RNTI, for the DCI, the RNTI including an indication that the one or more bits of the DCI have been configured to indicate that the resource allocation for the uplink transmission is based on the total number of the uplink resource units in the one or more uplink frequency sets or that the resource allocation for the downlink transmission is based on the total number of the downlink resource units in the one or more downlink frequency sets.

Paragraph 31. A method according to any of paragraphs 28 to 29, comprising
configuring one or more other bits in the DCI to indicate that the resource allocation for the uplink transmission is based on the total number of the uplink resource units in the one or more uplink frequency sets or that the resource allocation for the downlink transmission is based on the total number of the downlink resource units in the one or more downlink frequency sets.

Paragraph 32. A method according to any of paragraphs 28 to 29, wherein the control signal comprising the DCI is transmitted according to a search space and/or a control resource set, CORESET, and the search space and/or CORSET indicates that the resource allocation for the uplink transmission is based on the total number of the uplink resource units in the one or more uplink frequency sets or that the resource allocation for the downlink transmission is based on the total number of the downlink resource units in the one or more downlink frequency sets.

Paragraph 33. A method of operating communications device, the method comprising
receiving, from infrastructure equipment of a wireless communications network, a control signal indicating a resource allocation for transmitting an uplink transmission to the infrastructure equipment or receiving a downlink transmission from the infrastructure equipment within a set of contiguous resource units of a wireless radio interface, the resource allocation comprising a plurality of the resource units in the contiguous set of resource units for the uplink transmission or the downlink transmission,
applying a frequency domain mask to a sub-set of the plurality of resource units in the resource allocation, the frequency domain mask disabling the sub-set of the plurality of resource units in the resource allocation for transmitting the uplink transmission or receiving the downlink transmission,
transmitting the uplink transmission to the infrastructure equipment, or receiving the downlink transmission from the infrastructure equipment, in the other resource units in the resource allocation to which the frequency domain mask was not applied.

Paragraph 34. A method according to paragraph 33, wherein the control signal indicates a first of the plurality of resource units in the resource allocation and a number of the plurality of resource units the resource allocation.

Paragraph 35. A method according to paragraph 33 or paragraph 34, wherein the transmitting the uplink transmission to the infrastructure equipment, or receiving the downlink transmission from the infrastructure equipment, in the other resource units in the resource allocation to which the frequency domain mask was not applied comprises rate matching the uplink transmission or the downlink transmission around the subset of resource units to which the frequency domain mask was applied.

Paragraph 36. A method according to paragraph 33 or paragraph 34, wherein the transmitting the uplink transmission to the infrastructure equipment, or receiving the downlink transmission from the infrastructure equipment, in the other resource units in the resource allocation to which the frequency domain mask was not applied comprises
puncturing the resource units in the sub-set of the plurality of resource units to which the frequency domain mask was applied.

Paragraph 37. A method according to any of paragraphs 33 to 36, wherein the plurality of resources comprised in the resource allocation for the uplink or the downlink transmission comprise
one or more uplink and one or more downlink resource units, and wherein,
if the resource allocation is for the uplink transmission, the sub-set of the plurality of resource units in the resource allocation to which the frequency domain mask is applied comprises the one or more downlink resource units or,
if the resource allocation is for the downlink transmission, the sub-set of the plurality of resource units in the resource allocation to which the frequency domain mask is applied comprises the one or more uplink resource units.

Paragraph 38. A method according to any of paragraphs 33 to 37, wherein the plurality of resources in the resource allocation for the uplink or the downlink transmission comprises one or more guard resource units, and wherein
the sub-set of the plurality of resource units in the resource allocation to which the frequency domain mask is applied comprises the one or more guard resource units.

Paragraph 39. A method according to any of paragraphs 33 to 38, comprising
receiving one or more frequency domain masks from the infrastructure equipment each including an indication of a different sub-set of the plurality of resource units in the resource allocation to which the respective frequency domain mask applies, wherein the applying the frequency domain mask comprises
selecting to apply one of the received frequency domain masks.

Paragraph 40. A method according to paragraph 39, wherein the one or more frequency domain masks are received in downlink control information, DCI.

Paragraph 41. A method according to paragraph 39 or 40, wherein the selecting to apply one of the received frequency domain masks
receiving an activation indication for one of the received frequency domain masks, and
applying the frequency domain mask for which the activation indication was received.

Paragraph 42. A method according to any of paragraphs 39 to 41, wherein at least one of the received frequency domain masks is for the uplink transmission and at least one of the received frequency domain masks is for the downlink transmission, and wherein the selecting to apply one of the received frequency domain masks comprises
selecting to apply the at least one frequency domain mask for the uplink transmission if the resource allocation is for an uplink transmission, or
selecting to apply the at least one frequency domain mask for the downlink transmission if the resource allocation is for a downlink transmission.

Paragraph 43. A method according to any of paragraphs 33 to 42, wherein the set of contiguous resource units of the wireless access interface is a bandwidth part, BWP, of the wireless access interface.

Paragraph 44. A method of operating infrastructure equipment of a wireless communications network, the method comprising
transmitting, to a communications device, a control signal indicating a resource allocation for receiving an uplink transmission from the communications device or transmitting a downlink transmission to the communications device within a set of contiguous resource units of a wireless radio interface, the resource allocation comprising a plurality of the resource units in the contiguous set of resource units for the uplink transmission or the downlink transmission,
transmitting, to the communications device, a frequency domain mask indicating a sub-set of the plurality of resource units in the resource allocation for the communications device to disable for the uplink transmission or the downlink transmission, and
receiving the uplink transmission from the communications device, or transmitting the downlink transmission to the communications device, in the other resource units in the resource allocation which were not indicated by the frequency domain mask.

Paragraph 45. A method according to paragraph 44, wherein the control signal indicates a first of the plurality of resource units in the resource allocation and a number of the plurality of resource units the resource allocation.

Paragraph 46. A method according to paragraph 44 or paragraph 45, wherein the receiving the uplink transmission from the communications device, or transmitting the downlink transmission to the communications device, in the other resource units in the resource allocation to which the frequency domain mask was not applied comprises
rate matching the uplink transmission or the downlink transmission around the subset of resource units to which the frequency domain mask was applied.

Paragraph 47. A method according to paragraph 44 or paragraph 45, wherein the receiving the uplink transmission from the communications device, or transmitting the downlink transmission to the communications device, in the other resource units in the resource allocation to which the frequency domain mask was not applied comprises
puncturing the resource units in the sub-set of the plurality of resource units to which the frequency domain mask was applied.

Paragraph 48. A method according to any of paragraphs 44 to 47, wherein the plurality of resource units comprised in the resource allocation for the uplink or the downlink transmission comprise
one or more uplink and one or more downlink resource units, and wherein,
if the resource allocation is for the uplink transmission, the sub-set of the plurality of resource units in the resource allocation indicated by the frequency domain mask comprises the one or more downlink resource units or,
if the resource allocation is for the downlink transmission, the sub-set of the plurality of resource units in the resource allocation indicated by the frequency domain mask comprises the one or more uplink resource units.

Paragraph 49. A method according to any of paragraphs 44 to 48, wherein the plurality of resource units in the resource allocation for the uplink or the downlink transmission comprises one or more guard resource units, and wherein
the sub-set of the plurality of resource units in the resource allocation indicated by the frequency domain mask comprises the one or more guard resource units.

Paragraph 50. A method according to any of paragraphs 44 to 49, wherein the transmitting the frequency domain mask to the communications device comprises
transmitting a plurality of frequency domain masks to the communications device each including an indication of a different sub-set of the plurality of resource units in the resource allocation to which the respective frequency domain mask applies.

Paragraph 51. A method according to paragraph 50, wherein the one or more of the frequency domain masks are transmitted in downlink control information, DCI.

Paragraph 52. A method according to paragraph 50 or 51, comprising
transmitting an activation indication for one of the transmitted frequency domain masks.

Paragraph 53. A method according to any of paragraphs 50 to 52, wherein at least one of the plurality of frequency domain masks is for the uplink transmission and at least one of the plurality of frequency domain masks is for the downlink transmission.

Paragraph 54. A method according to any of paragraphs 44 to 53, wherein the set of contiguous resource units of the wireless access interface is a bandwidth part, BWP, of the wireless access interface.

Paragraph 55. A communications device, the communications device comprising
a transmitter configured to transmit signals,
a receiver configured to receive signals, and
a controller configured in combination with the transmitter and the receiver to
receive, from infrastructure equipment of a wireless communications network, a control signal configured with one or more bits to indicate a resource allocation for transmitting an uplink transmission to the infrastructure equipment or receiving a downlink transmission from the infrastructure equipment within a set of contiguous resource units of a wireless radio interface, wherein the set of contiguous resource units comprises one or more uplink frequency sets each comprising a plurality of uplink resource units and one or more downlink frequency sets each comprising a plurality of downlink resource units, the resource allocation comprising at least one of the uplink resource units in the one or more uplink frequency sets for the uplink transmission or at least one of the downlink resource units in the one or more downlink frequency sets for the downlink transmission, and wherein
the control signal is configured with the one or more bits to either
indicate the resource allocation for the uplink transmission based on a total number of the uplink resource units in the one or more uplink frequency sets, or
indicate the resource allocation for the downlink transmission based on a total number of the downlink resource units in the one or more downlink frequency sets, wherein the controller is configured in combination with the transmitter and the receiver to
determine the resource allocation for the uplink or the downlink transmission based on the one or more bits,
transmit the uplink transmission to the infrastructure equipment or receive the downlink transmission from the infrastructure equipment in accordance with the resource allocation.

Paragraph 56. Infrastructure equipment for a wireless communications network, the infrastructure equipment comprising
a transmitter configured to transmit signals,
a receiver configured to receive signals, and
a controller configured in combination with the transmitter and the receiver to
determine that the infrastructure equipment is either to receive an uplink transmission from a communications device or to transmit a downlink transmission to the communications device within a set of contiguous resource units of a wireless radio interface, wherein the set of contiguous resource units comprises one or more uplink frequency sets each comprising a plurality of uplink resource units and one or more downlink frequency sets each comprising a plurality of downlink resource units,
configure a control signal with one or more bits to either
indicate a resource allocation for the uplink transmission comprising at least one of the uplink resource units in the one or more uplink frequency sets, wherein the control signal is configured with the one or more bits to indicate the resource allocation for the uplink transmission based on a total number of the uplink resource units in the one or more uplink frequency sets, or
indicate a resource allocation for the downlink transmission comprising at least one of the downlink resource units in the one or more downlink frequency sets, wherein the control signal is configured with the one or more bits to indicate the resource allocation for the downlink transmission based on a total number of the downlink resource units in the one or more downlink frequency sets, and wherein the controller is configured in combination with the transmitter and the receiver to
transmit, to the communications device, the control signal including the one or more bits configured to indicate the resource allocation for the uplink or the downlink transmission, and
receive the uplink transmission from the communications device or transmit the downlink transmission to the communications device in accordance with the resource allocation.

Paragraph 57. A communications device, the communications device comprising
a transmitter configured to transmit signals,
a receiver configured to receive signals, and
a controller configured in combination with the transmitter and the receiver to
receive, from infrastructure equipment of a wireless communications network, a control signal indicating a resource allocation for transmitting an uplink transmission to the infrastructure equipment or receiving a downlink transmission from the infrastructure equipment within a set of contiguous resource units of a wireless radio interface, the resource allocation comprising a plurality of the resource units in the contiguous set of resource units for the uplink transmission or the downlink transmission,
apply a frequency domain mask to a sub-set of the plurality of resource units in the resource allocation, the frequency domain mask disabling the sub-set of the plurality of resource units in the resource allocation for transmitting the uplink transmission or receiving the downlink transmission,
transmit the uplink transmission to the infrastructure equipment, or receive the downlink transmission from the infrastructure equipment, in the other resource units in the resource allocation to which the frequency domain mask was not applied.

Paragraph 58. Infrastructure equipment for a wireless communications network, the infrastructure equipment comprising
a transmitter configured to transmit signals,
a receiver configured to receive signals, and
a controller configured in combination with the transmitter and the receiver to
transmit, to a communications device, a control signal indicating a resource allocation for receiving an uplink transmission from the communications device or transmitting a downlink transmission to the communications device within a set of contiguous resource units of a wireless radio interface, the resource allocation comprising a plurality of the resource units in the contiguous set of resource units for the uplink transmission or the downlink transmission,
transmit, to the communications device, a frequency domain mask indicating a sub-set of the plurality of resource units in the resource allocation for the communications device to disable for the uplink transmission or the downlink transmission, and
receive the uplink transmission from the communications device, or transmit the downlink transmission to the communications device, in the other resource units in the resource allocation which were not indicated by the frequency domain mask.

Paragraph 59. Circuitry for a communications device, the circuitry comprising
transmitter circuitry configured to transmit signals,
receiver circuitry configured to receive signals, and
controller circuitry configured in combination with the transmitter circuitry and the receiver circuitry to
receive, from infrastructure equipment of a wireless communications network, a control signal configured with one or more bits to indicate a resource allocation for transmitting an uplink transmission to the infrastructure equipment or receiving a downlink transmission from the infrastructure equipment within a set of contiguous resource units of a wireless radio interface, wherein the set of contiguous resource units comprises one or more uplink frequency sets each comprising a plurality of uplink resource units and one or more downlink frequency sets each comprising a plurality of downlink resource units, the resource allocation comprising at least one of the uplink resource units in the one or more uplink frequency sets for the uplink transmission or at least one of the downlink resource units in the one or more downlink frequency sets for the downlink transmission, and wherein
the control signal is configured with the one or more bits to either
indicate the resource allocation for the uplink transmission based on a total number of the uplink resource units in the one or more uplink frequency sets, or
indicate the resource allocation for the downlink transmission based on a total number of the downlink resource units in the one or more downlink frequency sets, wherein the controller circuitry is configured in combination with the transmitter circuitry and the receiver circuitry to
determine the resource allocation for the uplink or the downlink transmission based on the one or more bits,
transmit the uplink transmission to the infrastructure equipment or receive the downlink transmission from the infrastructure equipment in accordance with the resource allocation.

Paragraph 60. Circuitry for infrastructure equipment of a wireless communications network, the circuitry comprising
transmitter circuitry configured to transmit signals,
receiver circuitry configured to receive signals, and
controller circuitry configured in combination with the transmitter circuitry and the receiver circuitry to
determine that the infrastructure equipment is either to receive an uplink transmission from a communications device or to transmit a downlink transmission to the communications device within a set of contiguous resource units of a wireless radio interface, wherein the set of contiguous resource units comprises one or more uplink frequency sets each comprising a plurality of uplink resource units and one or more downlink frequency sets each comprising a plurality of downlink resource units,
configure a control signal with one or more bits to either
indicate a resource allocation for the uplink transmission comprising at least one of the uplink resource units in the one or more uplink frequency sets, wherein the control signal is configured with the one or more bits to indicate the resource allocation for the uplink transmission based on a total number of the uplink resource units in the one or more uplink frequency sets, or
indicate a resource allocation for the downlink transmission comprising at least one of the downlink resource units in the one or more downlink frequency sets, wherein the control signal is configured with the one or more bits to indicate the resource allocation for the downlink transmission based on a total number of the downlink resource units in the one or more downlink frequency sets, and wherein the controller circuitry is configured in combination with the transmitter circuitry and the receiver circuitry to
transmit, to the communications device, the control signal including the one or more bits configured to indicate the resource allocation for the uplink or the downlink transmission, and
receive the uplink transmission from the communications device or transmit the downlink transmission to the communications device in accordance with the resource allocation.

Paragraph 61. Circuitry for a communications device, the circuitry comprising
transmitter circuitry configured to transmit signals,
receiver circuitry configured to receive signals, and
controller circuitry configured in combination with the transmitter circuitry and the receiver circuitry to
receive, from infrastructure equipment of a wireless communications network, a control signal indicating a resource allocation for transmitting an uplink transmission to the infrastructure equipment or receiving a downlink transmission from the infrastructure equipment within a set of contiguous resource units of a wireless radio interface, the resource allocation comprising a plurality of the resource units in the contiguous set of resource units for the uplink transmission or the downlink transmission,
apply a frequency domain mask to a sub-set of the plurality of resource units in the resource allocation, the frequency domain mask disabling the sub-set of the plurality of resource units in the resource allocation for transmitting the uplink transmission or receiving the downlink transmission,
transmit the uplink transmission to the infrastructure equipment, or receive the downlink transmission from the infrastructure equipment, in the other resource units in the resource allocation to which the frequency domain mask was not applied.

Paragraph 62. Circuitry for infrastructure equipment of a wireless communications network, the circuitry comprising
transmitter circuitry configured to transmit signals,
receiver circuitry configured to receive signals, and
controller circuitry configured in combination with the transmitter circuitry and the receiver circuitry to
transmit, to a communications device, a control signal indicating a resource allocation for receiving an uplink transmission from the communications device or transmitting a downlink transmission to the communications device within a set of contiguous resource units of a wireless radio interface, the resource allocation comprising a plurality of the resource units in the contiguous set of resource units for the uplink transmission or the downlink transmission,
transmit, to the communications device, a frequency domain mask indicating a sub-set of the plurality of resource units in the resource allocation for the communications device to disable for the uplink transmission or the downlink transmission, and
receive the uplink transmission from the communications device, or transmit the downlink transmission to the communications device, in the other resource units in the resource allocation which were not indicated by the frequency domain mask.

Paragraph 63. A wireless communications system comprising a communications device according to paragraph 55 and infrastructure equipment according to paragraph 56.

Paragraph 64. A wireless communications system comprising a communications device according to paragraph 57 and infrastructure equipment according to paragraph 58.

Paragraph 65. A computer program comprising instructions which, when loaded onto a computer, cause the computer to perform a method according to any of paragraphs 1 to 54.

Paragraph 66. A non-transitory computer-readable storage medium storing a computer program according to paragraph 65.

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more data processors and/or digital signal processors. The elements and components of any embodiment may be physically, functionally and logically implemented in any suitable way. Indeed, the functionality may be implemented in a single unit, in a plurality of units or as part of other functional units. As such, the disclosed embodiments may be implemented in a single unit or may be physically and functionally distributed between different units, circuitry and/or processors.

Although the present disclosure has been described in connection with some embodiments, it is not intended to be limited to the specific form set forth herein. Additionally, although a feature may appear to be described in connection with particular embodiments, one skilled in the art would recognise that various features of the described embodiments may be combined in any manner suitable to implement the technique.

### REFERENCES

[1] Holma H. and Toskala A, “LTE for UMTS OFDMA and SC-FDMA based radio access”, John Wiley and Sons, 2009.
[2] TR 38.913, “Study on Scenarios and Requirements for Next Generation Access Technologies (Release 14)”, 3rd Generation Partnership Project, v14.3.0, August 2017.
[3] RP-213591, “New SI: Study on evolution of NR duplex operation,” CMCC, RAN #94e, December 2021.
[4] RP-220633, “Revised SID: Study on evolution of NR duplex operation,” CMCC, RAN #95e, March 2022.
[5] European Patent No. 3545716.
[6] TS 38.214, “Physical layer procedures for data (Release-17),” 3rd Generation Partnership Project, v17.1.0, April 2022.

1. A method of operating communications device, the method comprising
receiving, from infrastructure equipment of a wireless communications network, a control signal configured with one or more bits to indicate a resource allocation for transmitting an uplink transmission to the infrastructure equipment or receiving a downlink transmission from the infrastructure equipment within a set of contiguous resource units of a wireless radio interface, wherein the set of contiguous resource units comprises one or more uplink frequency sets each comprising a plurality of uplink resource units and one or more downlink frequency sets each comprising a plurality of downlink resource units, the resource allocation comprising at least one of the uplink resource units in the one or more uplink frequency sets for the uplink transmission or at least one of the downlink resource units in the one or more downlink frequency sets for the downlink transmission, and wherein
the control signal is configured with the one or more bits to either
indicate the resource allocation for the uplink transmission based on a total number of the uplink resource units in the one or more uplink frequency sets, or
indicate the resource allocation for the downlink transmission based on a total number of the downlink resource units in the one or more downlink frequency sets, and the method comprises
determining the resource allocation for the uplink or the downlink transmission based on the one or more bits,
transmitting the uplink transmission to the infrastructure equipment or receiving the downlink transmission from the infrastructure equipment in accordance with the resource allocation.

2. A method according to claim 1, wherein a number of the bits included in the control signal is based on the total number of uplink resource units in the one or more uplink frequency sets if the resource allocation is for the uplink transmission, or based on the total number of downlink resource units in the one or more downlink frequency sets if the resource allocation is for the downlink transmission.

3. A method according to claim 2, wherein the number of bits included in the control signal is proportional to the total number of uplink resource units in the one or more sets of uplink frequency sets if the resource allocation is for the uplink transmission, or proportional to the total number of downlink resource units in the one or more sets of downlink frequency sets if the resource allocation is for the downlink transmission.

4. A method according to claim 1, wherein
the plurality of uplink resource units in each of the one or more uplink frequency sets are grouped into one or more groups of contiguous uplink resource units based on the total number of the uplink resource units in the one or more uplink frequency sets, wherein the at least one uplink resource unit in the resource allocation comprises one or more of the groups and each bit is configured to indicate one of the groups in the resource allocation, or
the plurality of downlink resource units in each of the one or more downlink frequency sets are grouped into one or more groups of contiguous downlink resource units based on the total number of the downlink resource units in the one or more downlink frequency sets, wherein the at least one downlink resource unit in the resource allocation comprises one or more of the groups and each bit is configured to indicate one of the groups in the resource allocation, and
the determining the resource allocation for the uplink or the downlink transmission based on the one or more bits comprises
determining the one or more groups in the resource allocation based on the one or more bits.

5. A method according to claim 4, wherein a number of the uplink or downlink resource units included in the each of the groups of contiguous uplink or downlink resource units is based on the total number of the uplink or downlink resource units in the one or more uplink or downlink frequency sets.

6. A method according to claim 4, wherein
a number of the uplink or downlink resource units included in each of the groups of contiguous uplink or downlink resources is based on a total number of the resource units in the set of contiguous resource units, and
a number of the groups of contiguous uplink or downlink resource units included in each of the uplink or downlink frequency sets is based on a proportion of the total number of uplink or downlink resource units in the one or more uplink or downlink frequency sets of the total number of the resource units in the set of contiguous resource units.

7. A method according to claim 1, wherein the determining the resource allocation for the uplink or the downlink transmission based on the one or more bits comprises
determining, based on the one or more bits, a first uplink or downlink resource unit in the resource allocation, and
determining, based on the one or more bits, a number of uplink or downlink resource units in the resource allocation.

8. A method according to claim 1, wherein
an index for the set of contiguous resource units comprises a plurality of entries each identifying one of the plurality of uplink or downlink resource units,
an uplink sub-index for one or more of the uplink frequency sets comprises the entries in the index which identify the uplink resource units in the one or more uplink frequency sets for the one or more of the uplink frequency sets,
a downlink sub-index for one or more of the downlink frequency sets comprises the entries in the index which identify the downlink resource units in the one or more downlink frequency sets for the one or more of the downlink frequency sets, wherein
if the resource allocation is for the uplink transmission,
receiving the uplink sub-index from the infrastructure equipment, and wherein the determining the resource allocation for the uplink transmission based on the one or more bits comprises
determining, based on the one or more bits, the entries of the uplink sub-index which identify the one or more uplink resource units comprised in the resource allocation, or
if the resource allocation is for the downlink transmission,
receiving the downlink sub-index from the infrastructure equipment, and wherein the determining the resource allocation for the downlink transmission based on the one or more bits comprises
determining, based on the one or more bits, the entries of the downlink sub-index which identify the one or more downlink resource units comprised in the resource allocation.

9. A method according to claim 8, comprising
receiving an activation indication from the infrastructure equipment to activate the uplink or downlink sub-index.

10. A method according to claim 9, wherein the activation indication is received in downlink control information, DCI.

11. A method according to claim 1, wherein the set of contiguous resource units of the wireless access interface is a bandwidth part, BWP, of the wireless access interface.

12. A method according to claim 1, wherein the control signal comprises downlink control information, DCI, and the one or more bits are one or more bits of the DCI.

13.-32. (canceled)

33. A method of operating communications device, the method comprising
receiving, from infrastructure equipment of a wireless communications network, a control signal indicating a resource allocation for transmitting an uplink transmission to the infrastructure equipment or receiving a downlink transmission from the infrastructure equipment within a set of contiguous resource units of a wireless radio interface, the resource allocation comprising a plurality of the resource units in the contiguous set of resource units for the uplink transmission or the downlink transmission,
applying a frequency domain mask to a sub-set of the plurality of resource units in the resource allocation, the frequency domain mask disabling the sub-set of the plurality of resource units in the resource allocation for transmitting the uplink transmission or receiving the downlink transmission,
transmitting the uplink transmission to the infrastructure equipment, or receiving the downlink transmission from the infrastructure equipment, in the other resource units in the resource allocation to which the frequency domain mask was not applied.

34. A method according to claim 33, wherein the control signal indicates a first of the plurality of resource units in the resource allocation and a number of the plurality of resource units the resource allocation.

35. A method according to claim 33, wherein the transmitting the uplink transmission to the infrastructure equipment, or receiving the downlink transmission from the infrastructure equipment, in the other resource units in the resource allocation to which the frequency domain mask was not applied comprises
rate matching the uplink transmission or the downlink transmission around the subset of resource units to which the frequency domain mask was applied.

36. A method according to claim 33, wherein the transmitting the uplink transmission to the infrastructure equipment, or receiving the downlink transmission from the infrastructure equipment, in the other resource units in the resource allocation to which the frequency domain mask was not applied comprises
puncturing the resource units in the sub-set of the plurality of resource units to which the frequency domain mask was applied.

37. A method according to claim 33, wherein the plurality of resources comprised in the resource allocation for the uplink or the downlink transmission comprise
one or more uplink and one or more downlink resource units, and wherein,
if the resource allocation is for the uplink transmission, the sub-set of the plurality of resource units in the resource allocation to which the frequency domain mask is applied comprises the one or more downlink resource units or,
if the resource allocation is for the downlink transmission, the sub-set of the plurality of resource units in the resource allocation to which the frequency domain mask is applied comprises the one or more uplink resource units.

38. A method according to claim 33, wherein the plurality of resources in the resource allocation for the uplink or the downlink transmission comprises one or more guard resource units, and wherein
the sub-set of the plurality of resource units in the resource allocation to which the frequency domain mask is applied comprises the one or more guard resource units.

39. A method according to claim 33, comprising
receiving one or more frequency domain masks from the infrastructure equipment each including an indication of a different sub-set of the plurality of resource units in the resource allocation to which the respective frequency domain mask applies, wherein the applying the frequency domain mask comprises
selecting to apply one of the received frequency domain masks.

40.-57. (canceled)

58. Infrastructure equipment for a wireless communications network, the infrastructure equipment comprising
a transmitter configured to transmit signals,
a receiver configured to receive signals, and
a controller configured in combination with the transmitter and the receiver to
transmit, to a communications device, a control signal indicating a resource allocation for receiving an uplink transmission from the communications device or transmitting a downlink transmission to the communications device within a set of contiguous resource units of a wireless radio interface, the resource allocation comprising a plurality of the resource units in the contiguous set of resource units for the uplink transmission or the downlink transmission,
transmit, to the communications device, a frequency domain mask indicating a sub-set of the plurality of resource units in the resource allocation for the communications device to disable for the uplink transmission or the downlink transmission, and
receive the uplink transmission from the communications device, or transmit the downlink transmission to the communications device, in the other resource units in the resource allocation which were not indicated by the frequency domain mask.

59.-66. (canceled)
